(19) United States
(12) Patent Application Publication
(10) Pub. No.: US 2004/0024619 A1
(43) Pub. Date: Feb. 5, 2004

(54) System and method for facilitating the determination of property and casualty insurance rates

(76) Inventor: Joseph Patrick DiBella, Miami Beach, FL (US)

Correspondence Address: FLEIT KAIN GIBBONS GUTMAN & BONGINI, COURVOISIER CENTRE II, SUITE 404, 601 BRICKELL KEY DRIVE, MIAMI, FL, 33131, US

(21) Appl. No.: 10/417,424

(22) Filed: Apr. 15, 2003

Related U.S. Application Data
(60) Provisional application No. 60/380,644, filed on May 15, 2002.

(51) Int. Cl. G06F 17/60

(52) U.S. Cl. 705/4

(57) ABSTRACT

A system, for facilitating the determination of property and casualty insurance rates, is accessible by users as a desktop application or across a computer network, such as via a web site on the Internet. Each user can provide ratemaking data, in any flat-file format, to a computer or computer server, view and correct data entry errors found in the policy and claims databanks, perform sensitivity analyses, review a log of the input ratemaking parameters and the output rate level information that comprise each sensitivity analysis, review the effect of modifications to the system's default ratemaking parameters, select final input ratemaking parameters, and receive as a product of the system, insurance rates and actuarial exhibits.

### STATEMENT REGARDING FED SPONSORED R & D

Not Applicable

### DESCRIPTION OF ATTACHED APPENDIX

Not Applicable

### BACKGROUND OF THE INVENTION

1. Field of the Invention

This invention relates generally to the field of actuarial sciences and more specifically to a system and method for facilitating the determination of property and casualty (P&C) insurance rates.

2Description of the Prior Art

Insurance ratemaking is informed risk assessments based upon empirical data, observed trends, assumptions regarding underlying data, and judgment factors. Insurance rates are developed by ratemakers, often actuaries, who are either employed or commissioned by insurance companies. Ratemakers use several mathematical and logical techniques (algorithms) to develop insurance rates. Their work is submitted to regulatory authorities, which either accept or reject the rates being requested. Since the late 1970's, much of such work has been accomplished with high-level computer programming languages: first, in the early years, on mainframe terminals and now on desktop computers. Such languages include spreadsheet software and procedure-oriented languages such as APL. With ever improving hardware and software technology, the expectation levels in the depth, scope, and flexibility in insurance ratemaking, continue to rise.

Ratemaking is both a science and an art. There is no “cook book” or complete—“A to Z”—set of procedures that ratemakers follow to develop P&C insurance rates; nor should there be. There are dozens of tasks that must be completed in ratemaking. For each such task, there are often several alternative algorithms that a ratemaker considers in his determination of what would be most appropriate, given the nature of the insurance coverage and discerned patterns in the underlying data. The applicability of an algorithm is often based on assumptions that are rarely certain. Usually these algorithms have been widely published and employed. A ratemaker's experience, technical skills, and “feel for the numbers” weigh heavily in the worthiness of his product.

In a typical analysis, the ratemaker will first compute an indicated statewide rate change for each insurance coverage, and then allocate the overall rate change to individual classes of risks. He will measure each class of risk by assigning weights to the insurance company's and the industry's experience, and with the use of actuarial techniques and factors that he believes are most applicable and reasonable. Different ratemakers working on identical data could, often, develop significantly different rate change indications, particularly with regard to individual risk classifications. “Indicated” rate changes give rise to “selected” rate changes. The latter are submitted to regulatory authorities for approval and can be materially different from the “indicated” rate changes. “Selected” rate changes usually address marketing concerns, regulatory demands, and/or State laws. Rates that are too low will cause the insurer to lose money and, in the extreme, become insolvent, leaving both the company and its insureds without means to recoup their total losses. Rates that are too high in a non-competitive market will unfairly charge insureds more than their share of the actuarial risk. Rates that are too high in a competitive market will result in very little business for the insurance company, particularly in those markets where insurance agents scan the rates of several insurance companies when providing a quote to an applicant.

There is no known web-hosted P&C ratemaking software, no known P&C software which can “walk” non-highly-skilled ratemakers through the necessary steps in a series of “easy-to-understand” computer screens, and no known windowing environment which provides the ratemaker with a sensitivity (“What-If”) model that measures the sensitivity of output rate level information to alternative input ratemaking parameters. Certainly no such software is being marketed. Each insurance company has its own unique structure for storing its policy and claims underwriting data, each regulatory authority has its own rate filing requirements, and each company has its own approach to ratemaking. Nearly all ratemaking work is accomplished, either partly or completely, through the use of spreadsheet software.

Although spreadsheets give ratemakers a great deal of flexibility in customizing their work, they are unwieldy when they attempt to link the many algorithms that feed output data into each other. Rarely, if ever, can all the algorithms be software-linked as they can be with a procedural language. Because of the linkage limitation, such spreadsheet work does not have the capacity for testing multiple alternative actuarial techniques, weighting and combining alternative techniques, and providing for complicated sensitivity (“What-If”) analyses. Sensitivity analyses are usually performed, if at all, by skilled analysts. Managers (and CEO's), who typically have neither the time nor the skills to conduct sensitivity analyses, must rely on the ratemaker's judgment, or on a limited number of “What-If” printouts, if any. Accordingly, top management, as a rule, does not have the opportunity to personally measure the effect of high-leverage input ratemaking parameters and to determine the reasonableness of such parameters. In particularly competitive insurance markets, top management often looks at the rate level of certain competitors to determine what its own rates should be. This may be with a view toward a desired volume of premium or in the belief that they can make a profit at the competitor's rate level if the competitor is, in fact, profitable at its rate level. Management often second-guesses or overrules ratemakers, without full appreciation for the implied underlying and unarticulated assumptions. Often the ratemaker, too, has not quantified the implied assumptions. For example: a ratemaker may report that the overall “indicated” increase is 12%; top management may, however, order that the “selected” increase be 5% and never learn what the underlying implied assumptions are with regard to the “selected” value. This type of “top-down” decision-making begs the “bottoms-up” approach and reconciliation between the two methods.

A most time-consuming task, for a ratemaker, is the gathering and formatting of data. The task often takes as much time, if not more, as the actuarial analysis does. There are no industry standards as to how insurance companies are to store their data and no standards as to how the data are to be presented to ratemakers. Companies have unique risk classification systems (e.g., for automobile insurance: driver age/marital status/gender combinations; and territory definitions), unique accounting periods (e.g.: years, semi-years, quarters or months), unique databank layouts, and a myriad of other unique record-keeping approaches. Under ideal conditions, some of the input data represent 7, 3, 2, and 1 year(s) of history; some data are on an accident-year basis, if not on a policy-year basis, and other data are on a calendar-year basis. Furthermore, there is no standard format for the policy and claims underwriting data that are submitted to ratemakers. The customization work that must be accomplished with each rate analysis is a major reason why no known generalized ratemaking software is being marketed in the P&C insurance industry. A typical response, by a software developer to this type of disordered environment, might be to require users to re-format data and enter them into the ratemaking software “his way” (i.e., the developer's way) and no other way. A market for this type of software would be very limited: the software would involve time-consuming data processing conversions, and require users to have an expertise in actuarial sciences and familiarity with the unique input specifications of complicated software.

Another deficiency in spreadsheet analyses is its limited ability to detect and correct errors that may occur with data input and with ad hoc customization. Policy and Claims databanks often contain data entry errors such as incorrect codes for risk classifications, rating territory identities, insurance deductibles, insurance limits, and the State (of the Union). There is also the possibility that incorrect dollar amounts are entered for premiums, claims, or loss adjustment expenses. Ratemakers and their spreadsheet software rarely provide lists of the detected errors that their clients, the insurance companies, can address. Errors that arise from incorrect codes usually offset each other when included in statewide rate level calculations; but they can significantly distort the rate level indications for particular risk classifications within the State. Incorrect dollar amounts usually go undetected unless they are illogical negative values or unless they produce nonsensical averages. Ratemakers typically include the incorrect data in their statewide calculations and ignore such data in their risk classification analyses. Consequently, the indicated rates for certain classes of business can be materially incorrect.

Yet another deficiency is the rate filing review that regulatory authorities conduct: they do not have access to a user's sensitivity (“What-If”) analysis. To conduct such an analysis, a regulator would have to enter all the data that underly the development of the insurance rates, and of course, have access to “What-If” software. Access to the data and software, would not only provide the regulators with the ability to test the sensitivity of the proposed rate changes to the various rate making parameters, but also to examine the insurance company's parameters for soundness, fairness, and consistency (over time and amongst the various insurance coverages within a filing).

Accordingly, there is a need for a system to facilitate the determination of P&C insurance rates. There is also a need to accept any flat-file structure of policy and claims data. There is another need to detect data entry errors in policy and claims databanks. There is a further need to provide non-technical management personnel with sensitivity analyses. There is yet another need to provide regulatory authorities with the means to analyze ratemaking parameters for effect and consistency.

### BRIEF SUMMARY OF THE INVENTION

The primary object of the invention is to provide a data processing system containing means for the development of P&C insurance rates.

Another object of the invention is to provide a system that non-actuaries can operate.

Another object of the invention is to provide a web hosted ratemaking system.

A further object of the invention is to provide a data entry system that can accept any flat-file database structure of policy and claims underwriting experience.

Yet another object of the invention is to provide a system that detects, and allows users to correct, data entry errors found in policy and claims underwriting databanks.

Still yet another object of the invention is to provide sensitivity (“What-If”) analysis software for ratemakers, insurance company management personnel, and regulatory authorities.

A further object of the invention is to provide a means to append new policy and claims data to previously loaded policy and claims databanks.

Other objects and advantages of the present invention will become apparent from the following descriptions, taken in connection with the accompanying drawings, wherein, by way of illustration and example, an embodiment of the present invention is disclosed.

This invention utilizes a new system and method to facilitate the determination of P&C insurance rates for remotely located users. The system comprises a computer network and a computer server with software, written in procedural languages, in a windowing environment. The software is designed to “walk” non-actuaries through the necessary steps in a series of “easy-to-understand” computer web pages (windows). The ratemaking computer program accepts the user's policy and claims flat-file databanks in whatever format they may be. This is accomplished through a series of web pages that list, by way of drop-down list boxes, all the possible descriptions or identities of the fields for data being entered. The user needs only click on the applicable description or identity. In other cases, he is guided to textboxes that ask for numbers, codes, or descriptions. The user is directed from web page to web page until all the required data are entered. He does not need to re-format any data. Data are sent, via the network, to the computer server. The system is able to classify and re-format the data, and detect and accept corrections to certain data entry errors found in the policy and claims databanks. A data entry progress report and default values pertaining to certain insurance industry averages and certain industry trends are provided. Alternative ratemaking techniques are provided and their output can be weighted and combined. Actuarial exhibits and proposed insurance rates are automatically generated once all the data are entered into the system. A sensitivity analysis module allows rates and output rate level information, determined using different input ratemaking parameters, to be modified on a “What-If” basis and compared in a “What-If Notebook”. Regulatory authorities may be granted operational access to the user's sensitivity analysis. The effect of modifications to the system's recommended ratemaking parameters is provided. Copies of the actuarial exhibits, “What-If” analyses, and data entry screens exhibits can be stored as portable document format files on the user's computer and printed individually or in bulk. Entered data and selected input ratemaking parameters are archived for reference and future ratemaking analyses.

The foregoing objects and advantages are accomplished utilizing a system for facilitating the determination of property and casualty insurance rates that comprises a computer network interface; a computer server coupled to the computer network interface for receiving ratemaking data received from at least one user across a computer network, for processing the ratemaking data, and for sending rates and actuarial exhibits to the at least one user; and at least one communication device coupled to the computer network interface for sending the ratemaking data across the computer network to the computer server, for receiving from the computer server, the rates and the actuarial exhibits.

The inventive system for facilitating the determination of property and casualty insurance rates as described in the preceding paragraph may utilize a computer network that is a wide area network. Also, the computer network can be the Internet; with the computer server coupled to the Internet and the computer server operating with a web server to provide the at least one user access to the system for facilitating the determination of property and casualty insurance rates.

Also, the inventive system for facilitating the determination of property and casualty insurance rates may comprise a local area network coupled to the communication device and to the Internet wherein the computer network is the Internet; and the computer server is coupled to the Internet to provide the at least one user access to the system for facilitating the determination of property and casualty insurance rates.

In addition to the foregoing, the present invention provides a method for facilitating the determination of property and casualty insurance rates comprising the steps of: receiving ratemaking data from at least one user; and classifying the ratemaking data. Further, this method contemplates the additional step of at least one user sends ratemaking data to a computer server via the Internet. In the method of the present invention, the ratemaking data comprises any flat-file database of insurance policy and claims data. Further steps contemplated by the method include detecting and displaying data entry errors found in the policy and claims databanks, and accepting changes to the data entry errors. Also, the method includes the steps of formatting the ratemaking data, and storing the ratemaking data, and also, the step of providing default values pertaining to insurance industry averages or insurance industry trends. Still further the method contemplates the step of generating a data entry progress report, and/or generating a sensitivity analysis model comprising input ratemaking parameters and output rate level information. Still further steps, one or more of which can be included in the inventive method, include providing or generating a log for displaying the input ratemaking parameters and the output rate level information, selecting concluding input ratemaking parameters by the at least one user, generating an actuarial measure of the effect caused by a modification of default input ratemaking parameters, generating rates and actuarial exhibits, storing the ratemaking data for future ratemaking projects and appending new policy and claims data to the ratemaking data.

Other and further objects and advantages of the present invention will become apparent to those skilled in the art from the following detailed description of a preferred embodiment taken together with the appended drawings.

### BRIEF DESCRIPTION OF THE DRAWINGS

The drawings constitute a part of this specification and include exemplary embodiments to the invention, which may be embodied in various forms. It is to be understood that, in some instances, various aspects of the invention may be shown exaggerated or enlarged to facilitate an understanding of the invention.

FIGS. 1A to 1D are schematic block diagrams illustrating Alternative Computer Networks and their interaction with the ratemaking computer program.

FIG. 2 is a High-Level Depiction of the Ratemaking Routine that illustrates the overall, user operations.

FIG. 3 is a flow diagram of the Log In Subroutine.

FIG. 4 is a flow diagram of the Data Entry: Master Subroutine. The subroutine provides the user with links to a data entry status report and to six data entry subroutines for as many categories of data.

FIG. 5 is a flow diagram of the Policy and Claims Experience: Master Subroutine. The subroutine provides the user with links for loading policy and claims databanks and for indicating which insurance coverages are to be analyzed.

FIG. 6 is a flow diagram of the Policy and Claims, Data Entry Subroutine. The subroutine illustrates the programming logic used to accept any flat-file database structure.

FIG. 7 is a flow diagram of the Rate Change History, Data Entry Subroutine.

FIG. 8 is a flow diagram of the Risk Classification, Data Entry Subroutine.

FIG. 9 is a flow diagram of the Annual Statement, Data Entry Subroutine.

FIG. 10 is a flow diagram of the Trend Factors and Other Ratemaking Parameters, Data Entry Subroutine.

FIG. 11 is a flow diagram of the Miscellaneous Items, Data Entry Subroutine.

FIG. 12 is a flow diagram of the What-If Analysis, Subroutine. The diagram illustrates the programming procedures followed for testing the sensitivity of the ratemaking output to certain input ratemaking parameters.

FIG. 13 is a flow diagram of the What-If Notebook, Subroutine. The notebook stores the “What-If” analyses that the user elects to save.

FIG. 14 is a flow diagram of the Exhibits Subroutine which pertains to the viewing and creation of portable document format (PDF) files.

### DETAILED DESCRIPTION OF PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one, skilled in the art, to employ the present invention in virtually any appropriately detailed system, structure or manner.

This invention utilizes a method for facilitating the determination of Property and Casualty (P&C) insurance rates. It is accessible by users across a computer network, such as via a web site on the Internet. Users:

1. send underwriting experience and ratemaking data to a computer server,

2. identify and define valid databank codes,

3. view and correct data entry errors found in the policy and claims databanks,

4. perform sensitivity (“What-If”) analyses,

5. review a log (“What-If Notebook”) of input ratemaking parameters and output rate level information that comprise each “What-If” analysis,

6. select concluding input ratemaking parameters,

7. receive, as a product of the system, insurance rates, actuarial exhibits, and other regulatory rate filing exhibits,

8. convert exhibits into portable document format (PDF) files, and

9. further receive, as an additional product of the system, the ability for a regulatory authority to access and exercise the user's sensitivity “What-If” analysis.

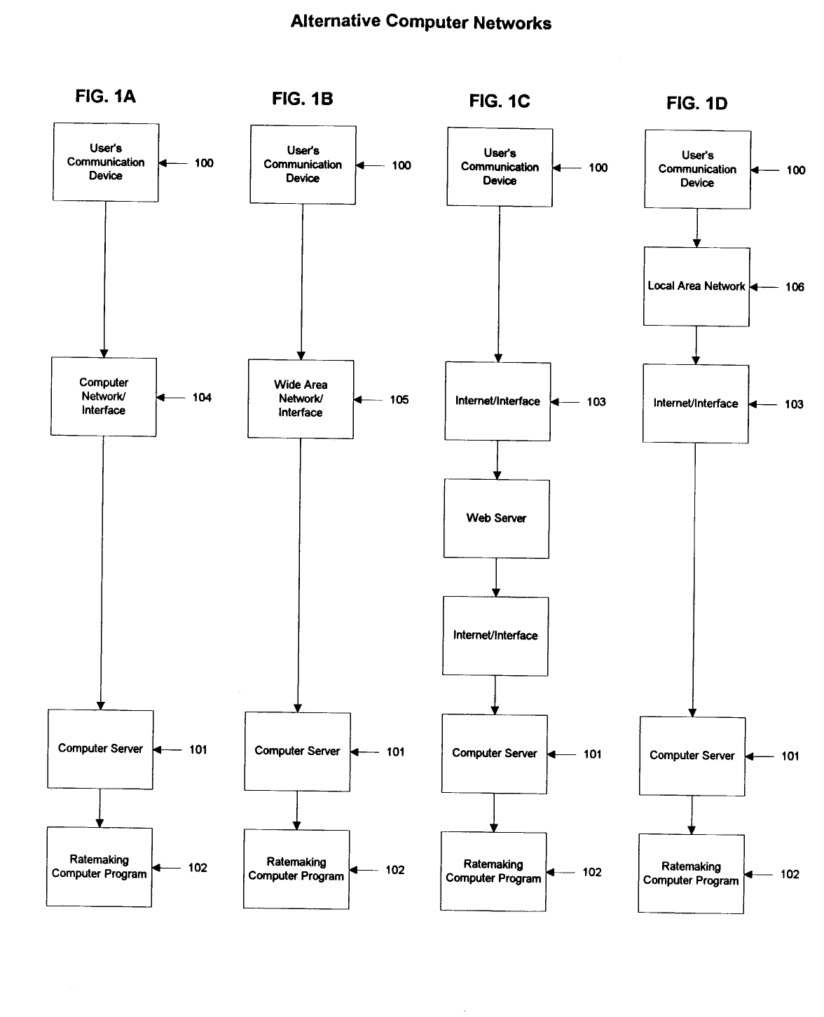

The block diagrams, labeled FIGS. 1A to 1D, illustrate alternative computer networks that can interface with the ratemaking computer program. In every illustrated case, there are:

1. the user's communication device 100, such as a PC, a handheld computer, or other portable communication device,

2. a computer server 101, and

3. the ratemaking computer program 102 that resides on the computer server 101.

The preferred embodiments to this invention are the third and fourth illustrated cases, FIGS. 1C and 1D, that include the Internet 103. The user's communication device 100 needs only have enough processing circuitry, input/output devices, and peripheral equipment so that it can communicate with the computer server 101 either directly, or indirectly via a network 103, 104, 105, or 106.

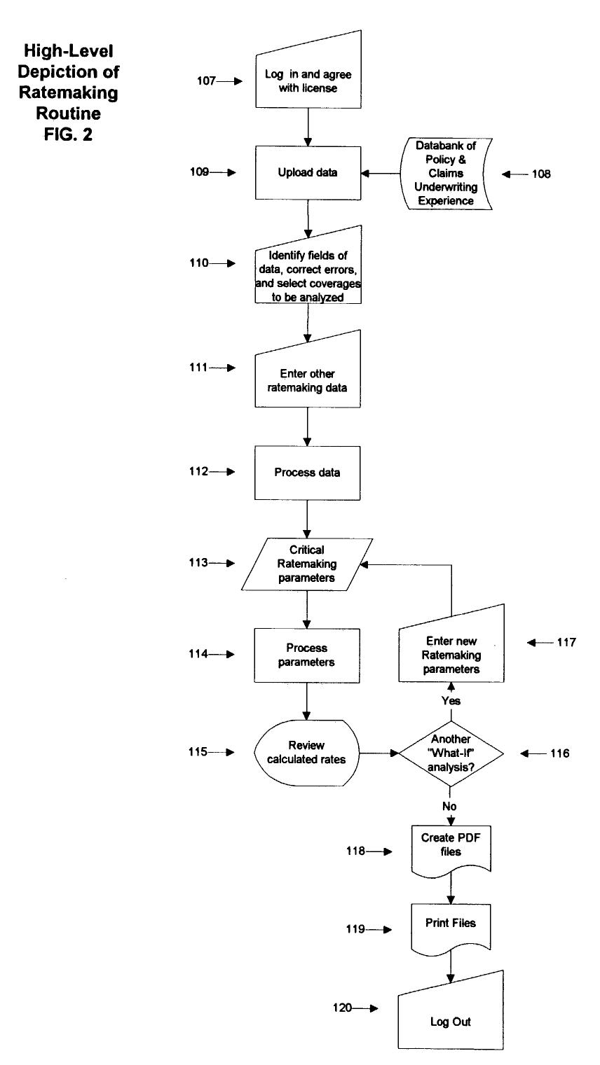

FIG. 2 is a high-level flow diagram of the ratemaking routine. After the user logs in and agrees with the license agreement 107, he uploads 109 his Policy and Claims Underwriting Experience 108 into the system. He then identifies the fields of data in his databanks, corrects detected errors, and selects the insurance coverages he wants the computer ratemaking program 102 to analyze 110. After additional ratemaking data are entered 111, the computer ratemaking program 102, using conventional actuarial algorithms, processes 112 all the data. The algorithms, that are interlinked and recursive, generate the initial values for certain critical ratemaking parameters 113. The initial values, in turn, are fed into, and processed 114 by, additional conventional actuarial algorithms. Insurance rates and actuarial exhibits 115 are automatically generated for the user's review once all the data are entered. The user has access to a “What-If” subroutine 116 that allows him to test the sensitivity of the generated rates to variations in the input ratemaking parameters 117. New rates 115 are automatically generated for each new saved set of input ratemaking parameters 117. When the user is satisfied with the calculated rates 115, he can create Portable Document Format (PDF) files 118 for printing 119, storing, and electronic transmission to a regulatory authority. The user logs out at 120.

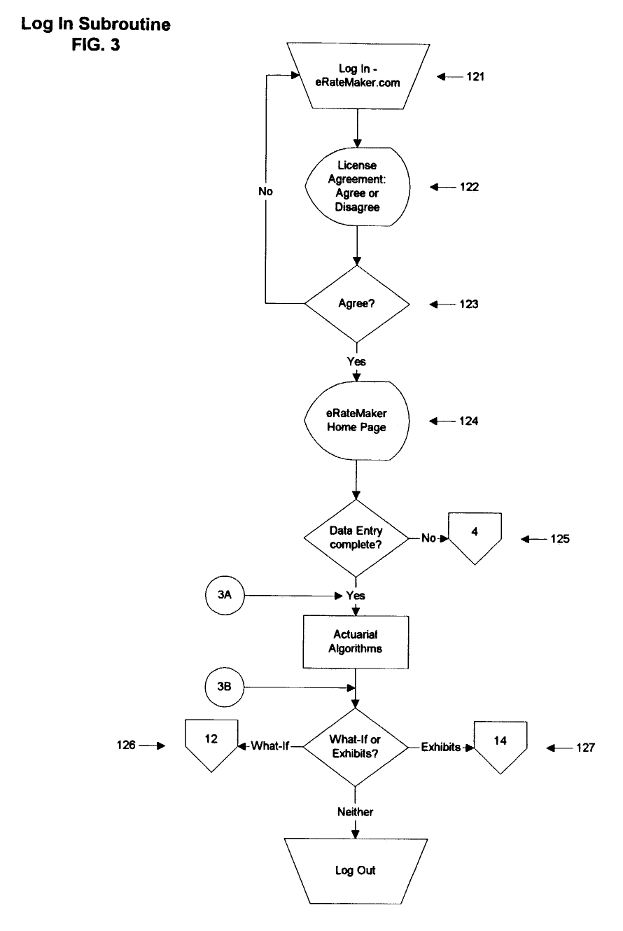

The user's operation begins with the “Log In” subroutine, FIG. 3. The user logs in 121, with a username, the applicable State, a password, and the pre-approved static Internet protocol (IP) address. When all the “log in” items are authenticated, the license agreement 122 is displayed. If the user agrees 123 with the agreement, he moves on to the “Home Page” 124; otherwise, the user is routed back to the “Log In” page where he is provided with the licensor's email address and telephone number.

Table 1 is a copy of the Home Page 124. The user can:

1. commence or continue “Data Entry” 125,

2. conduct a “What-If Analysis” 126, or

3. review and administer the actuarial “Exhibits” 127.

TABLE 1

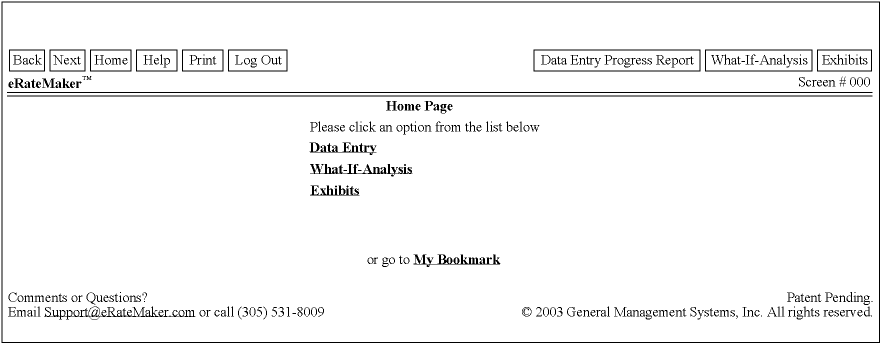

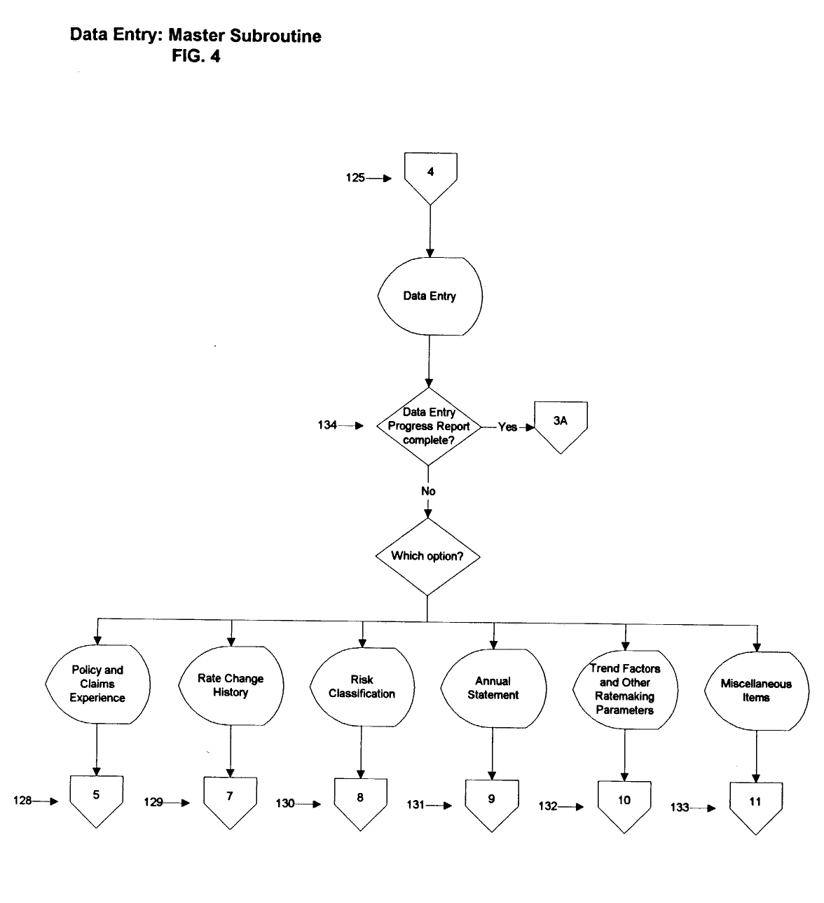

The “Data Entry” stage, the first of the system's three stages, has six data entry sub-systems as depicted in the web page, shown as Table 2, and as diagramed in FIG. 4.

Enter:

1. Policy and Claims Experience 128,

2. Rate Change History 129,

3. Risk Classification Data 130,

4. Annual Statement Data 131,

5. Trend Factors and Other Ratemaking Parameters 132; and

6. Miscellaneous Items 133.

TABLE 2

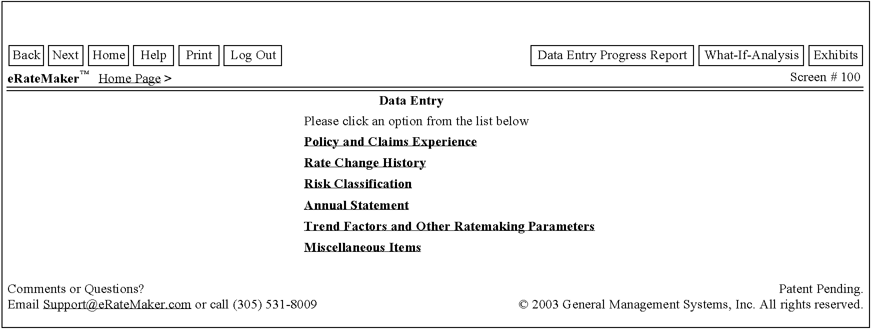

The web page navigation bar, entitled “Data Entry Progress Report”, as shown in Table 2 provides the user with continuous and immediate access to his data entry progress 134. Table 3 is an exemplary web page of a Data Entry Progress Report. The web page provides a status report, as to what data have been entered, and links to every data entry web page. The checkboxes to the left of each category are check-marked by the ratemaking computer program once all the data, for the particular category of data, have been entered.

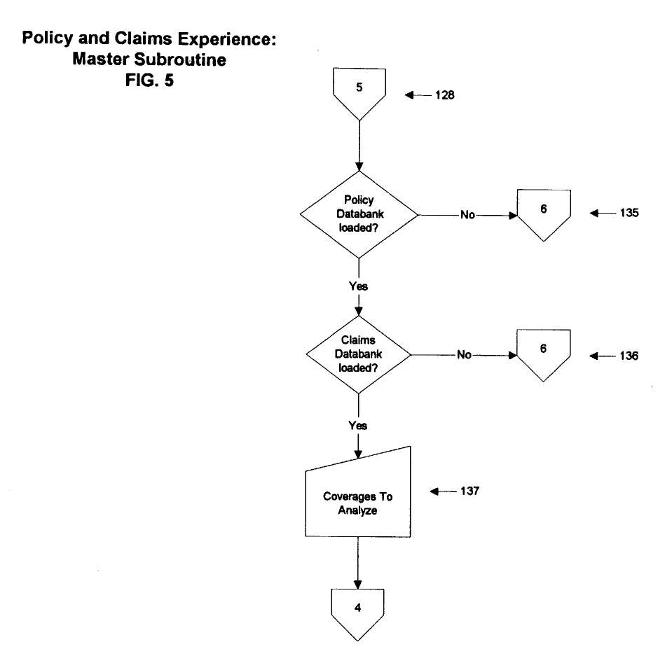

The first subsystem, “Policy and Claims Experience” 128, has three parts to it, as depicted in web page, shown as Table 4 and diagramed in FIG. 5. Load or select a:

1. Policy Databank 135,

2. Claims Databank 136, and

3. Coverages to Analyze 137.

TABLE 3

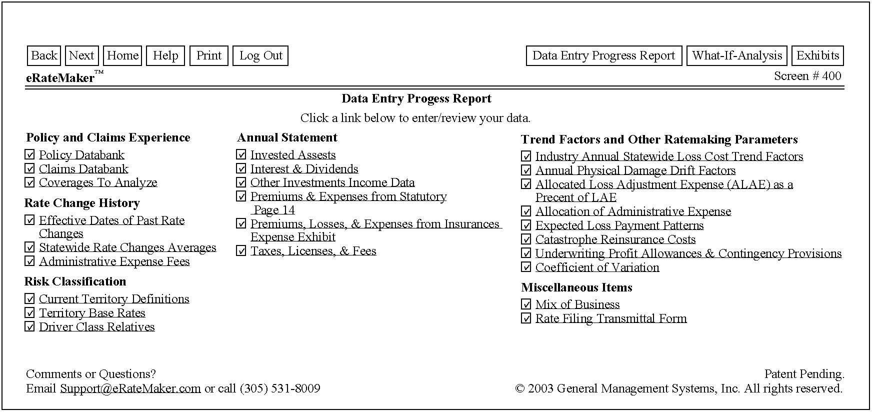

TABLE 4

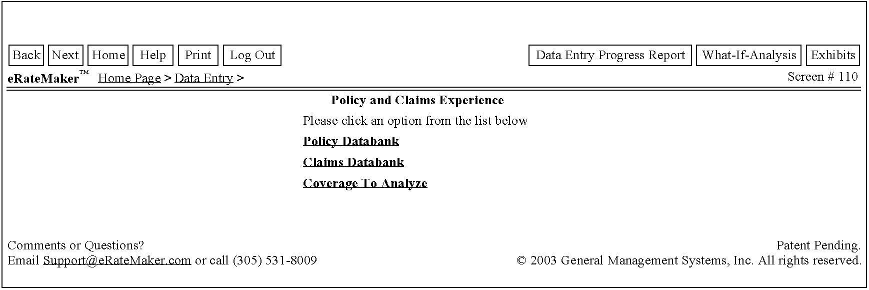

As diagrammed in FIG. 5, the user uploads, to the web-based ratemaking computer program, his policy 135 and claims 136 databanks, if he has not uploaded them in a previous session. He locates his files, through his communication device, by browsing, as illustrated in the web page shown as Table 5.

TABLE 5

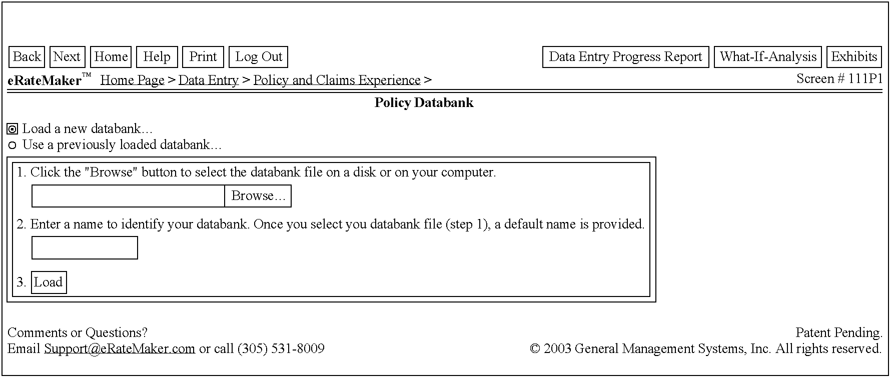

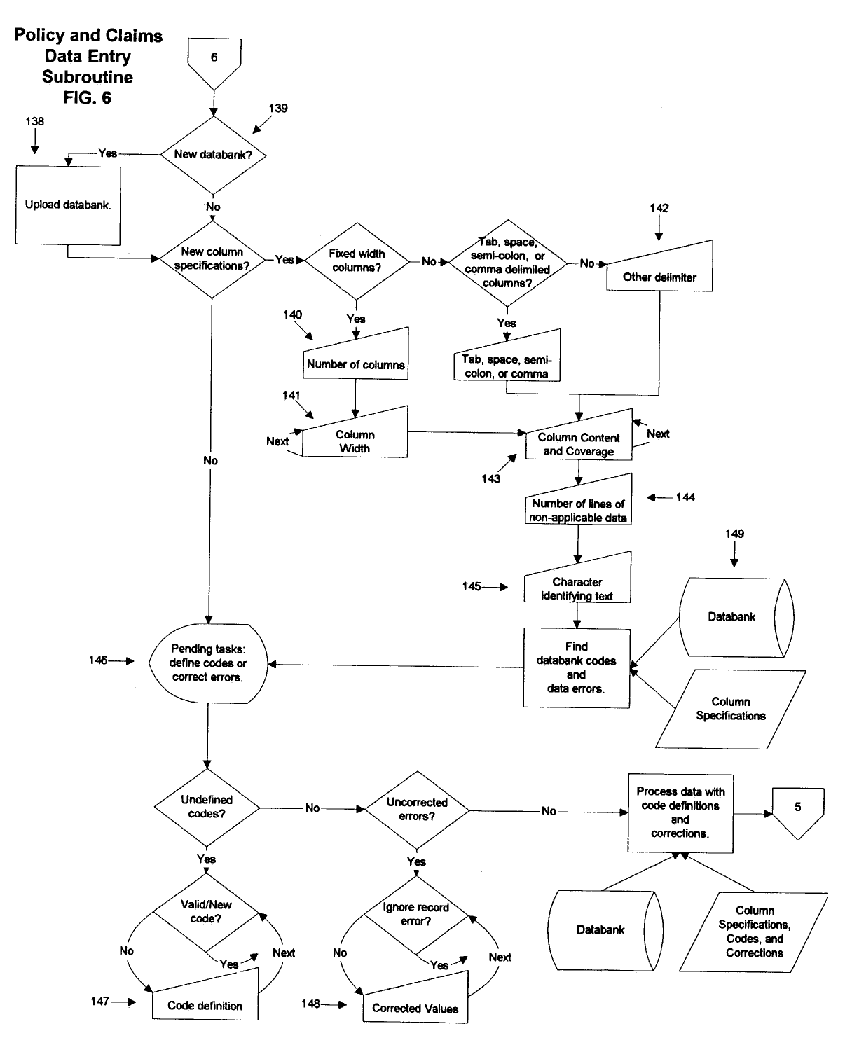

An important feature of the system is its ability to accept any flat-file database structure of policy and claims underwriting experience. This feature, by way of option buttons, drop-down list boxes and textboxes, precludes the need for the user to reformat his flat-file databanks before uploading them into the ratemaking computer program. The feature is illustrated in FIG. 6, the “Policy and Claims Data Entry subroutine” and in Table 6. The first five lines of the databank are listed on the web page. Succeeding lines, in packets of five, are accessible for viewing.

The user's first task, after he has uploaded 138 the new databank 139, is to identify the columns of data. If he has already identified each column in a previous session, he can select from a drop-down list, the name he assigned for the “Databank Column Specifications”, as shown in Table 6. If such specifications have not been established, named, and saved, his first task is to stipulate how the columns of data are delimited. The ratemaking computer program inserts vertical lines between each column of data, as shown in Table 6, once it is told what the column delimiter is. As illustrated, the columns in the databank are numbered by the ratemaking computer program, serially, for as many columns as there are in the databank, beginning with the number “1”. If the columns are fixed in width, the user must enter the number of columns 140, and the width of each column 141. If the delimiter is not represented by an option button, the user must enter the “another character” 142 before the vertical lines can be inserted between the columns of data.

TABLE 6

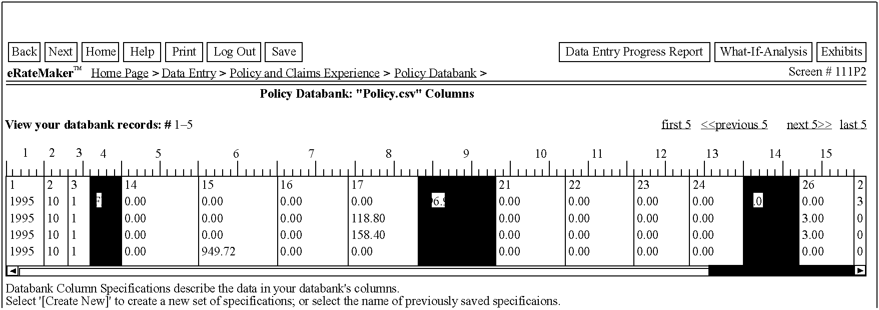

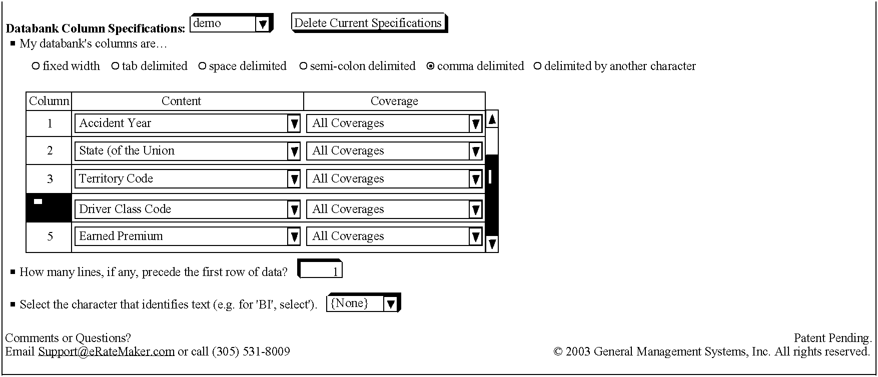

Next, the user must identify the content of each column. He accomplishes this task 143, by way of drop-down lists.

The drop-down lists in the “Content” column of the web page, shown in Table 6, contain lists of every known applicable category of underwriting experience. The user clicks on the category that identifies the data in the highlighted column.

The drop-down lists in the “Coverage” column of the web page, shown in Table 6, contain lists of all the possible applicable insurance coverages. The user clicks on whatever is applicable.

Next the user indicates how many lines of non-applicable data 144, if any, precede his first row of underwriting experience. He does this by way of a textbox as shown in Table 6. A default value, equal to “0”, is provided by the program.

The user's next task is to select, from a drop-down list box, as shown in Table 6, the character 145 that he may have in his databank, which identifies any text that his databank may contain.

The ratemaking computer program next displays the “Pending Tasks” 146, as illustrated in Table 7, an exemplary web page. Columns of data will have codes that the user must identify 147 and coverage data may have data entry errors that the user may want to correct 148.

The web page provides links to the codes that were found in the databank 149. Table 8 is an exemplary web page for the codes that were found in the “Accident Year” column of an exemplary databank. The user, with the aid of drop-down lists and textboxes, identifies 147 the codes. Each drop-down list provides a list of all the possible identities for the codes that were found in a selected column. The user also has the ability to indicate which codes found in the databank are invalid; and the ability to add valid codes which were not found in the databank.

TABLE 7

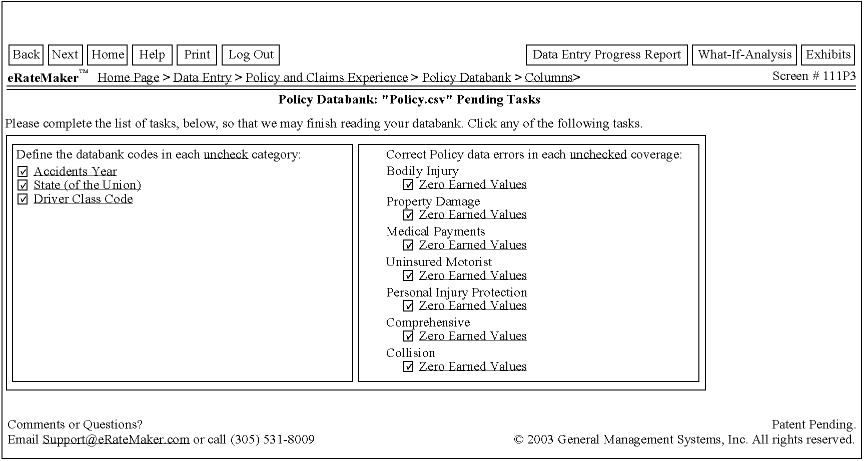

TABLE 8

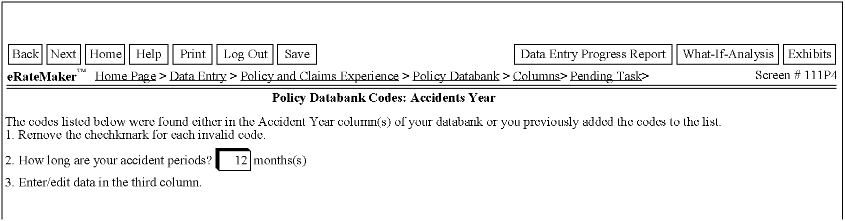

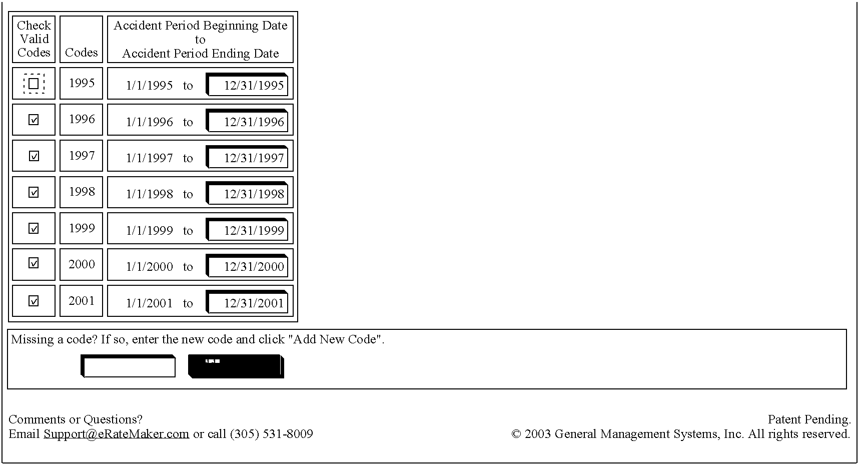

The detection and display of data entry errors in the Policy and claims databanks is an important feature of the invention. The ratemaking computer program will display every line of data that has one of the following errors:

1. Negative premiums (in toto) and/or negative units of exposure (in toto)

2. Positive premiums (in toto) and no units of exposure (in toto), or vice versa

3. Negative reported losses (in toto)

4. Negative claim counts (in toto)

5. Nil claim counts (in toto) with positive reported losses (in toto)

6. Positive claim counts (in toto) with nil premiums (in toto)

7. Invalid codes

The exemplary web page displayed as Table 7 also provides links to the lines of data with errors. The errors are sorted by insurance coverage. The user clicks on the described error to see a list of the lines of data with errors. Table 9 is an exemplary web page of detected errors. The first column, for each line of data, provides the user with a drop-down list box to “Ignore” or “Not Ignore” the line of data. If the user elects not to ignore the line of data, he is required to correct the error in a textbox 148.

If the user elects to use a previously uploaded databank, he selects the databank from a list of names that he provided when the databanks were originally uploaded, as illustrated in exemplary web page, shown as Table 10. The system archives data for future analyses. New policy and claims data can be appended to previously loaded databanks. Like web pages are provided for the claims databank.

The last task that the user must complete in this first data entry subsystem, (“Enter Policy and Claims Experience”), is to indicate which insurance coverages he would like the ratemaking computer program to analyze. This is accomplished by way of option buttons 137 as illustrated in the exemplary web page shown as Table 11.

TABLE 9

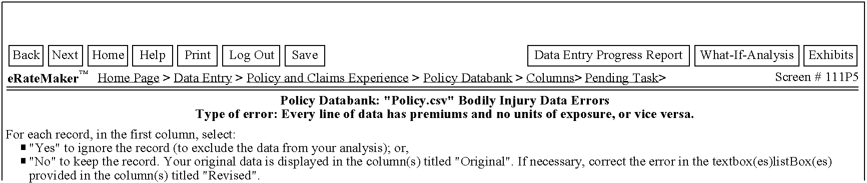

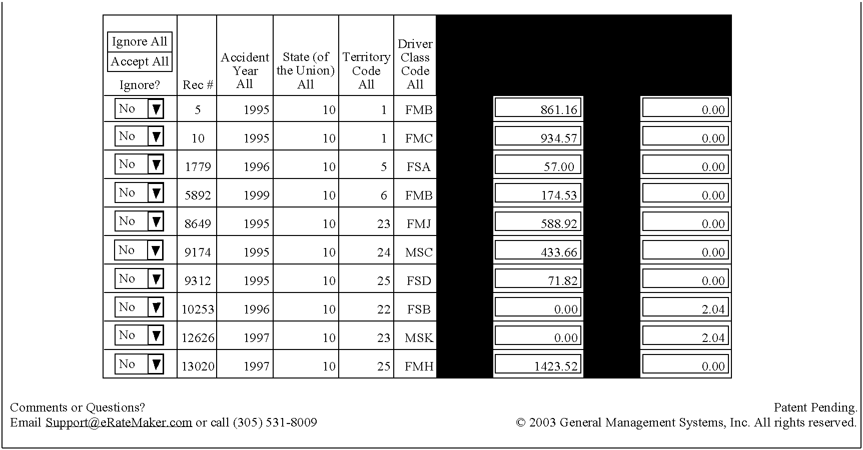

TABLE 10

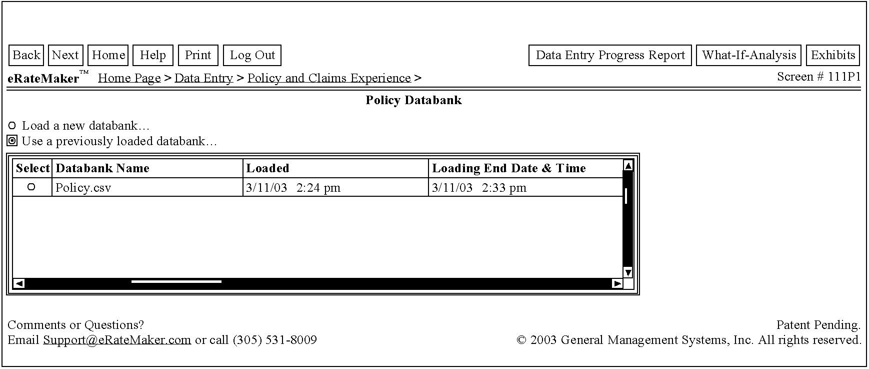

TABLE 11

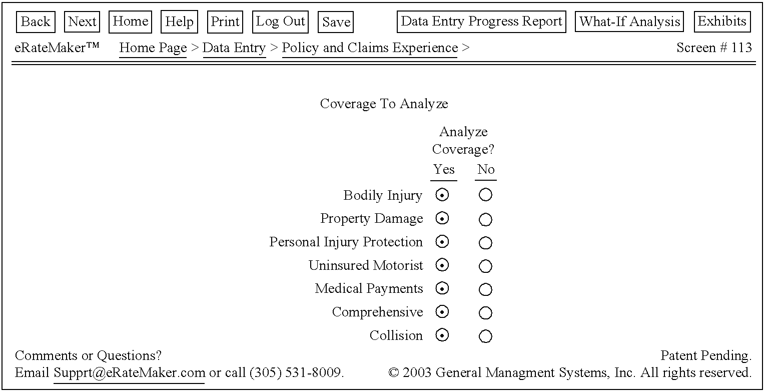

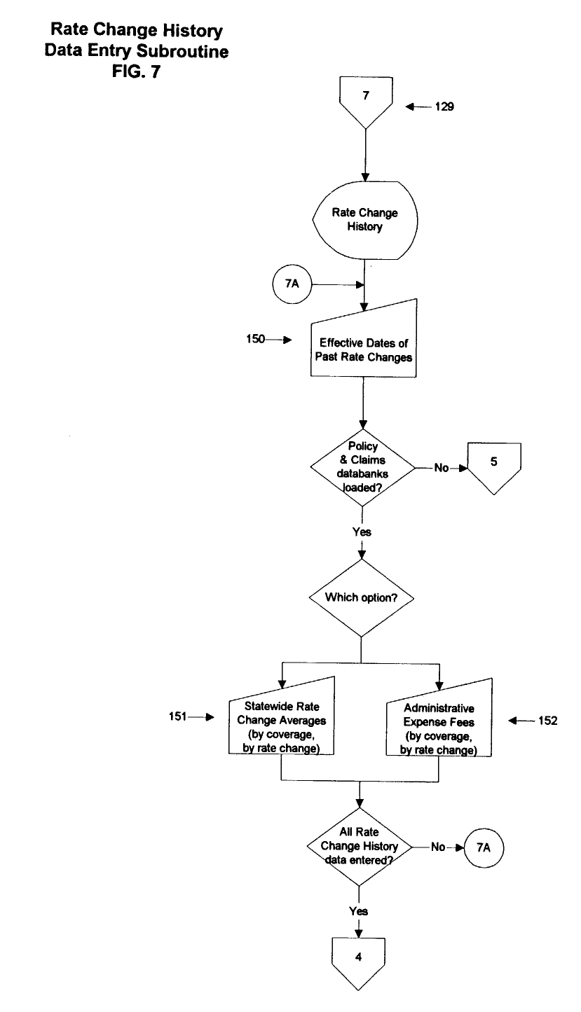

The second date entry subsystem that the user enters is the “Rate Change History”. It has three steps as indicated in the web page shown as Table 12 and as flow diagramed in FIG. 7. Enter:

1. Effective Dates of past Rate Changes 150,

2. Statewide Rate Changes Averages 151, and

3. Administrative Expense Fees 152.

TABLE 12

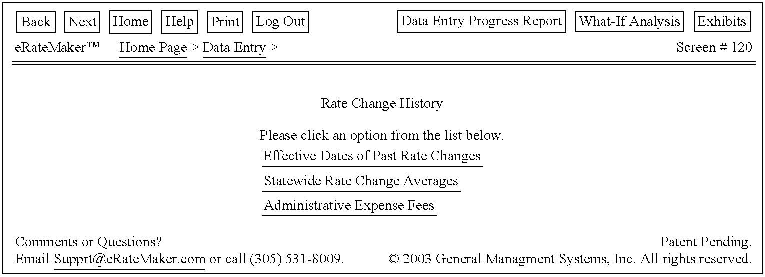

The “Effective Dates of Past Rate Changes” section accepts the effective dates 150, for “New Business” and “Renewal Business”, for all rate changes made during the four years preceding the ending date of the latest accident year, as illustrated in the exemplary web page shown as Table 13.

TABLE 13

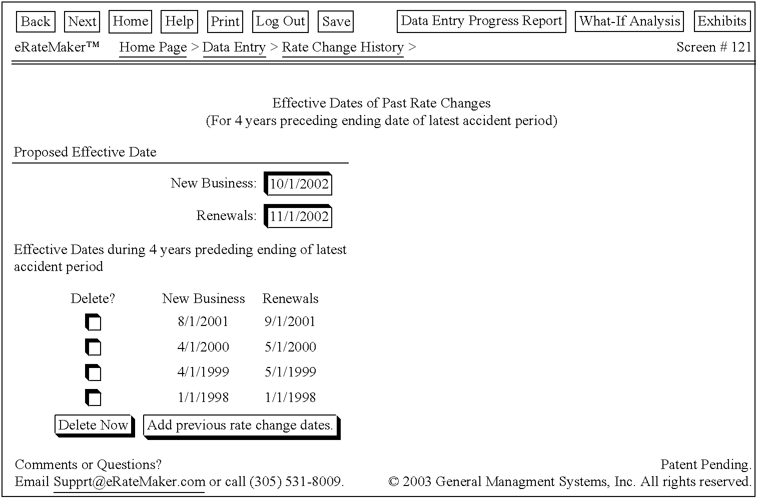

The “Statewide Rate Change Averages” section accepts the recent average statewide rate change (percent increase or decrease), by coverage, for each rate change 151 made during the four years preceding the ending date of the latest accident year, as illustrated in the exemplary web page shown as Table 14.

The “Administrative Expense Fee History” section accepts the recent history of the fees charged, if any, for each coverage, for each rate change 152 made during the four years preceding the ending date of the latest accident year, as illustrated in the exemplary web page shown as Table 15.

TABLE 14

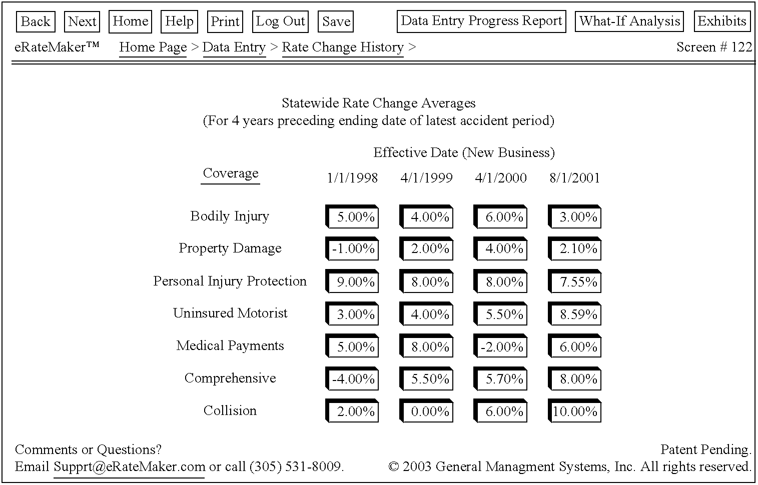

TABLE 15

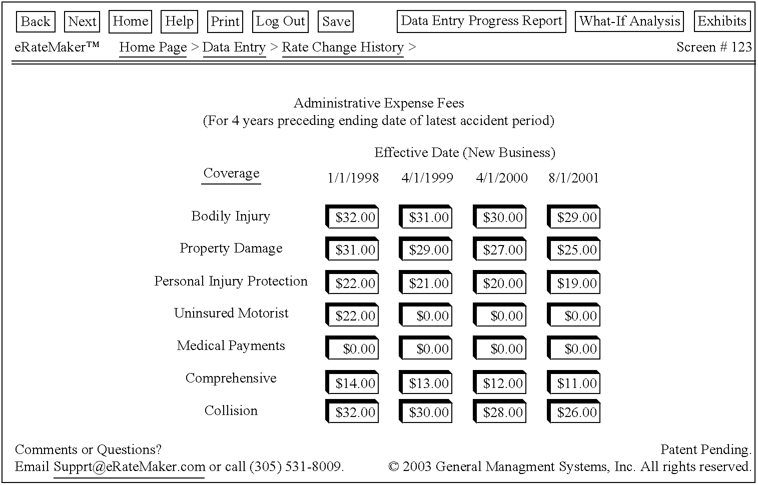

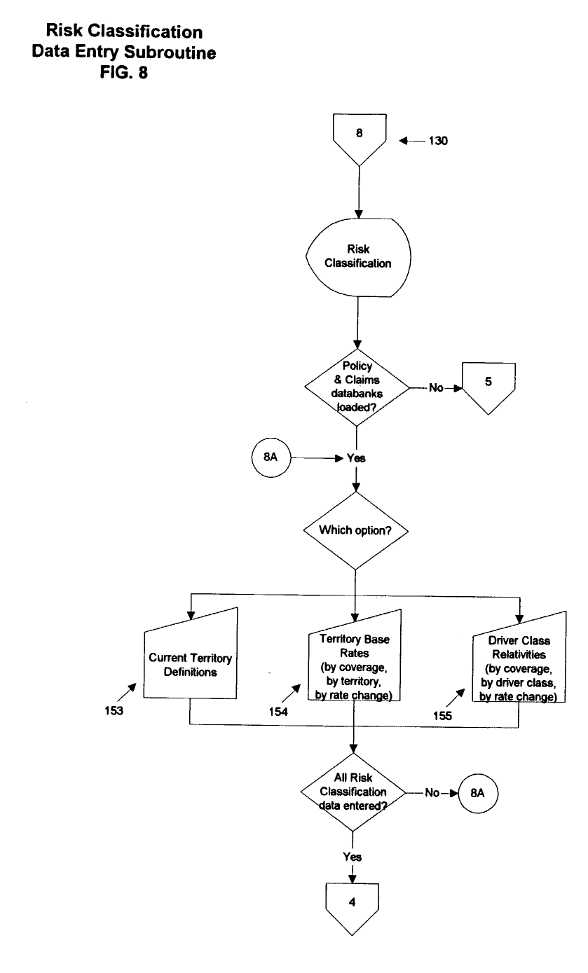

The next and third data entry subsystem is for “Risk Classification” data. It has three steps, as illustrated in the exemplary web page shown as Table 16 and as flow diagrammed in FIG. 8. Enter:

1. Current Territory Definitions 153,

2. Territory Base Rates 154, and

3. Driver Class Relativities 155.

TABLE 16

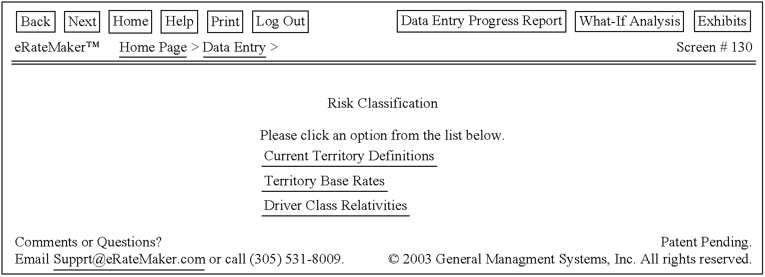

The “Current Territory Definitions” section accepts identification codes, names, and zip codes when applicable, for each rating territory 153, as illustrated in the exemplary web page shown as Table 17.

TABLE 17

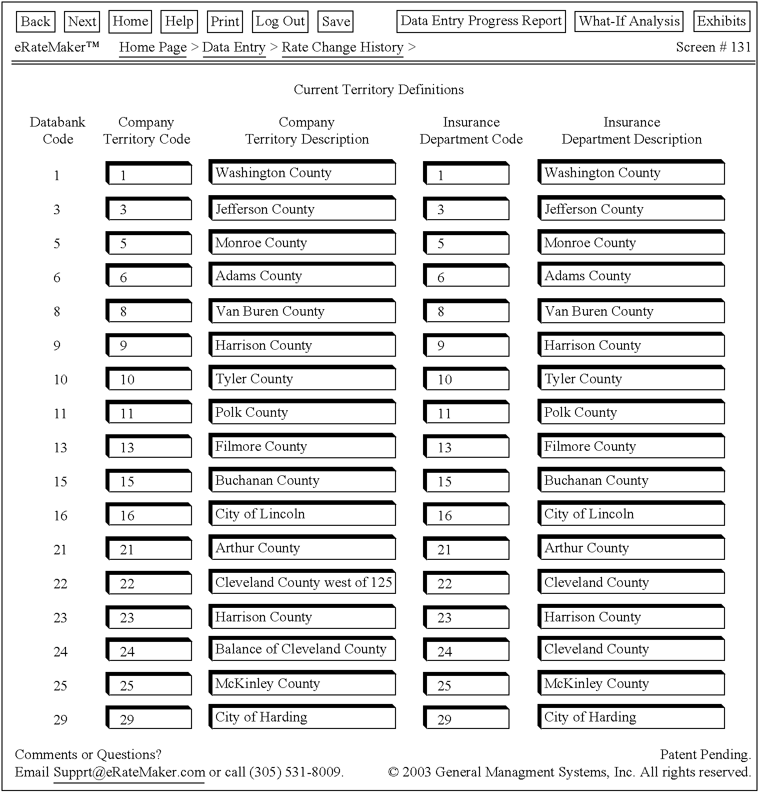

The “Territory Base Rates” section accepts the recent history of the base rates for each territory, by effective date 154, as illustrated in the exemplary web pages shown as Table 18 and Table 19.

TABLE 18

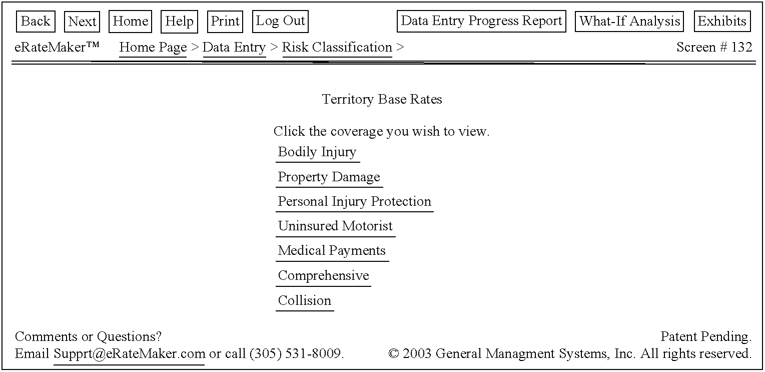

TABLE 19

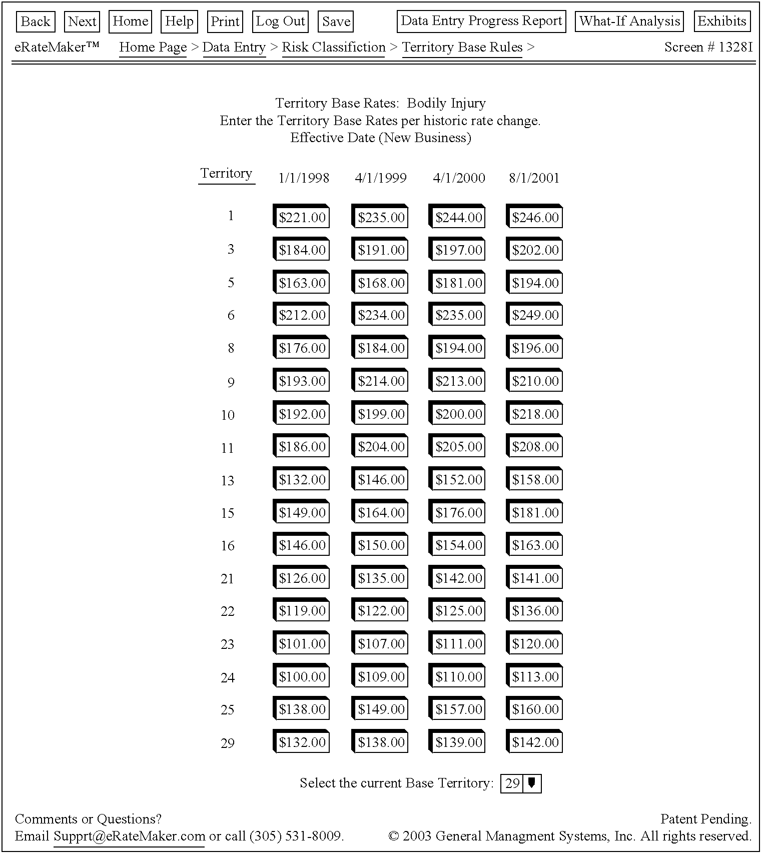

The “Driver Class Relativities” (by coverage) section accepts the recent history of the relativity factors for each driver class, by effective date 155, as illustrated in the exemplary web pages shown as Table 20 and Table 21.

TABLE 20

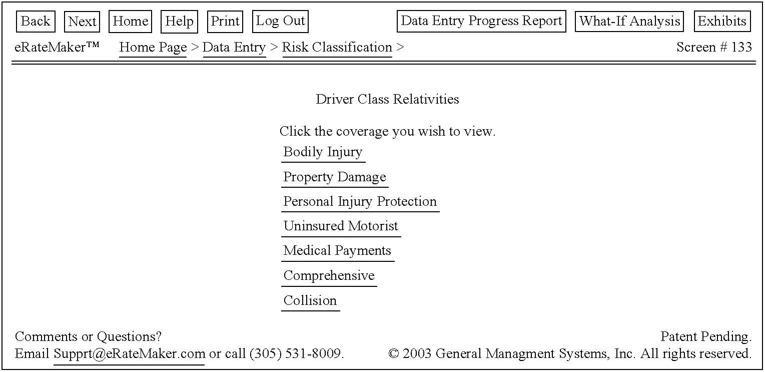

TABLE 21

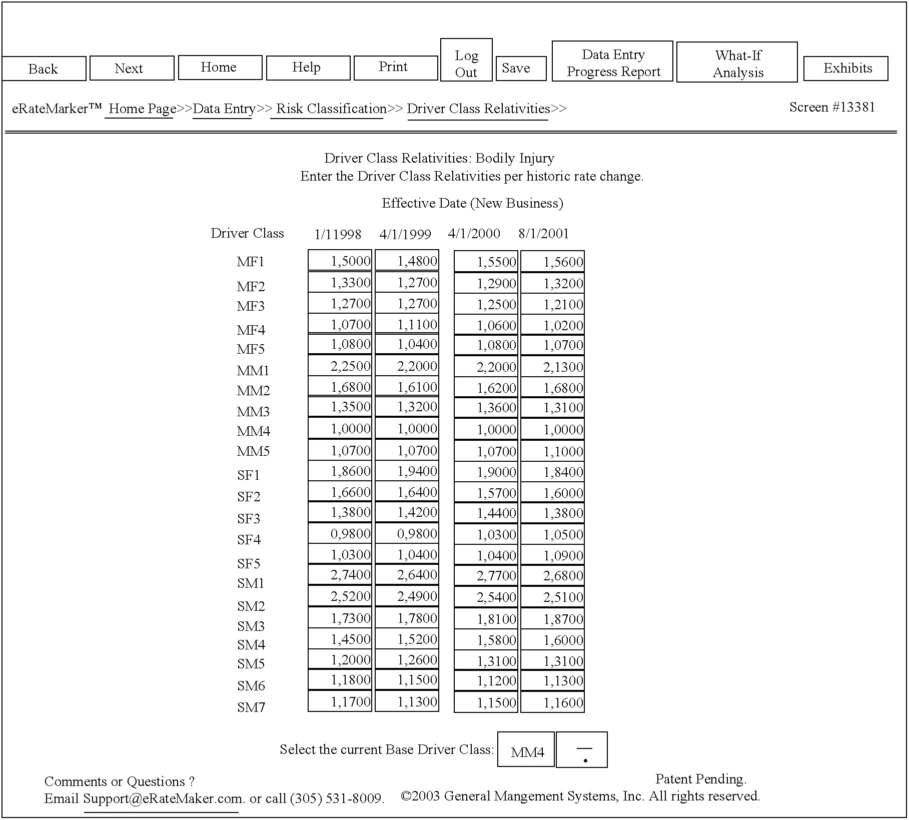

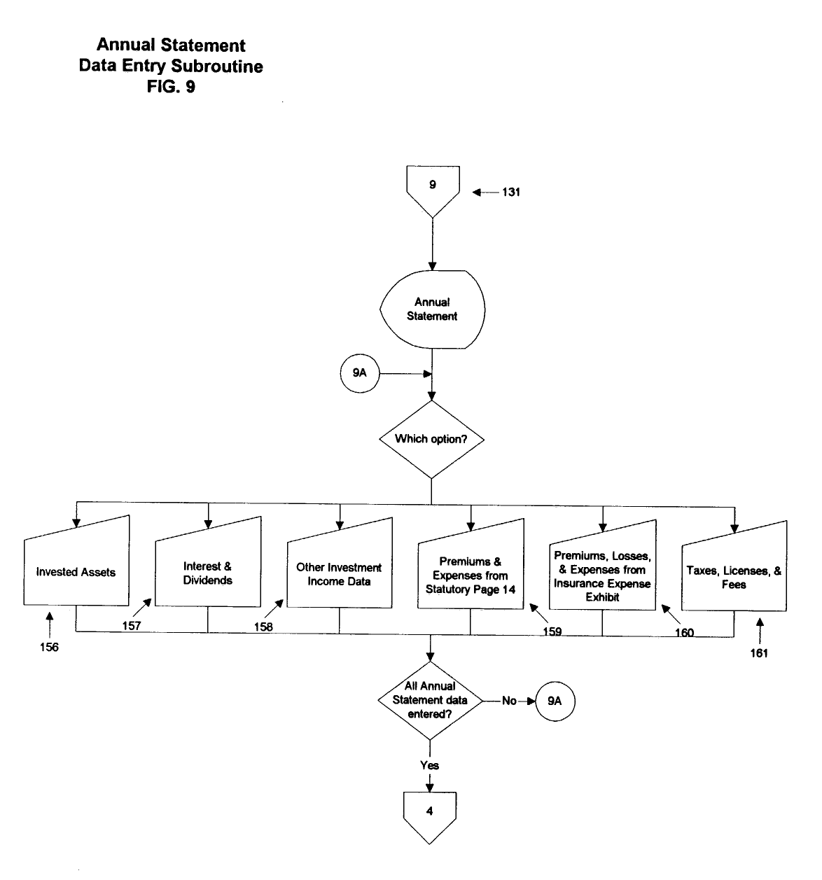

The fourth data entry subsystem pertains to “Annual Statement” data. It has six steps, as illustrated in the web page shown as Table 22 and as flow diagrammed in FIG. 9. Enter:

1. Invested Assets 156,

2. Interest & Dividends 157,

3. Other Investment Income data 158,

4. Premiums & Expenses from Statutory Page 14 159,

5. Premiums, Losses, & Expenses from Insurance Expense Exhibit 160, and

6. Taxes, Licenses, & Fees 161.

TABLE 22

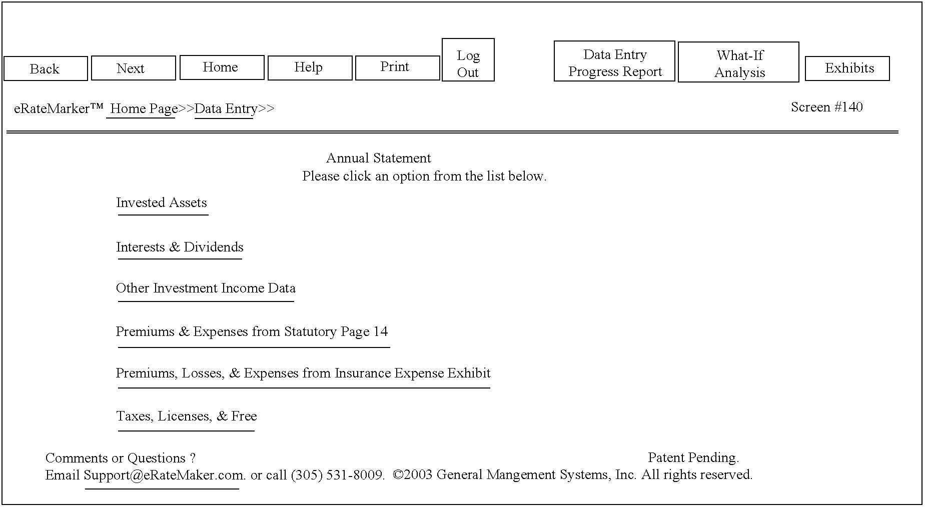

The “Invested Assets” section accepts the investment portfolio values for stocks, bonds, and cash, for December 31 of the latest two years 156, as illustrated in the exemplary web page shown as Table 23.

The “Interest & Dividends” section accepts the investment income earned by type of investment, and investment expenses incurred, for the latest fiscal year 157, as illustrated in the exemplary web page shown as Table 24.

TABLE 23

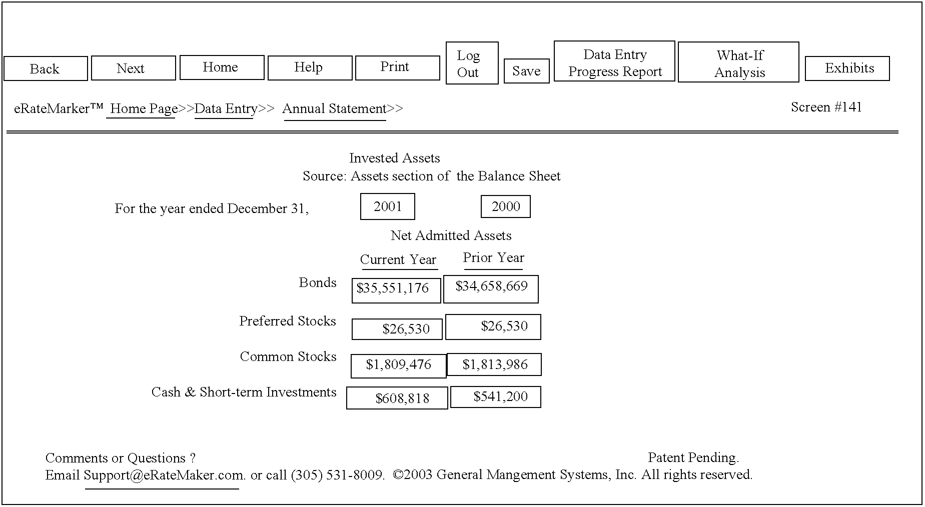

TABLE 24

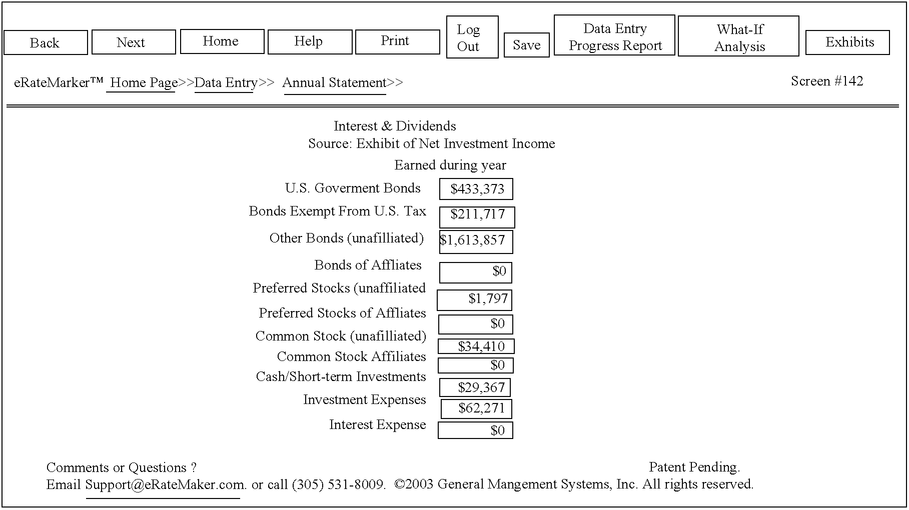

The “Other Investment Income Data” section accepts current income tax rates and factors, and projections that apply to invested assets 158, as illustrated in the exemplary web page shown as Table 25. Default values are offered.

TABLE 25

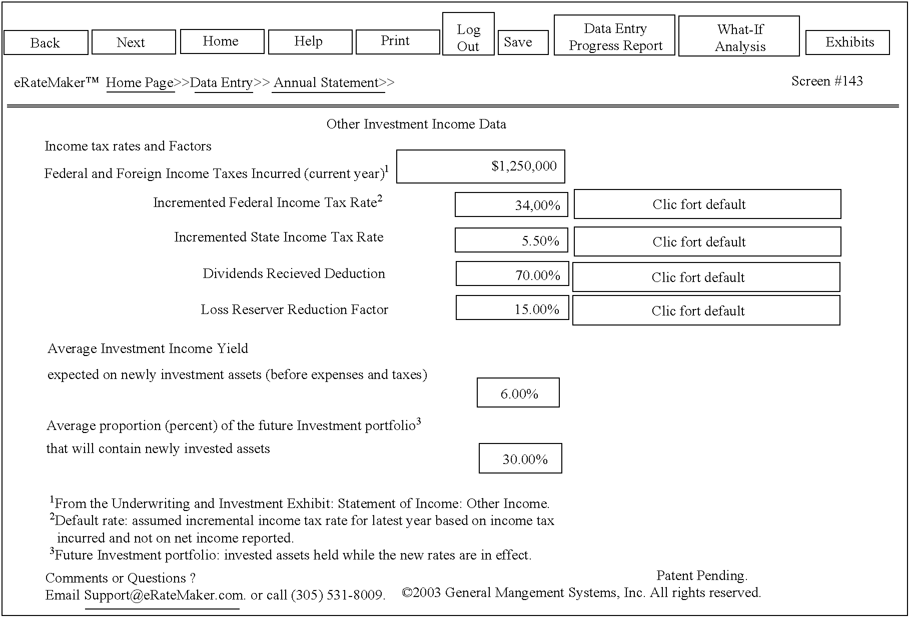

The “Premiums & Expenses from Statutory Page 14” section accepts premiums written and earned, and certain expenses incurred, for the latest fiscal year, by line of business, for the State in which the rates are being filed 159, as illustrated in the exemplary web page shown as Table 26.

The “Premiums, Losses, & Expenses from Insurance Expense Exhibit” section accepts premiums written and earned, and certain expenses incurred, for the latest fiscal year, by line of business, on a countrywide basis 160, as illustrated in the exemplary web page shown as Table 27.

TABLE 26

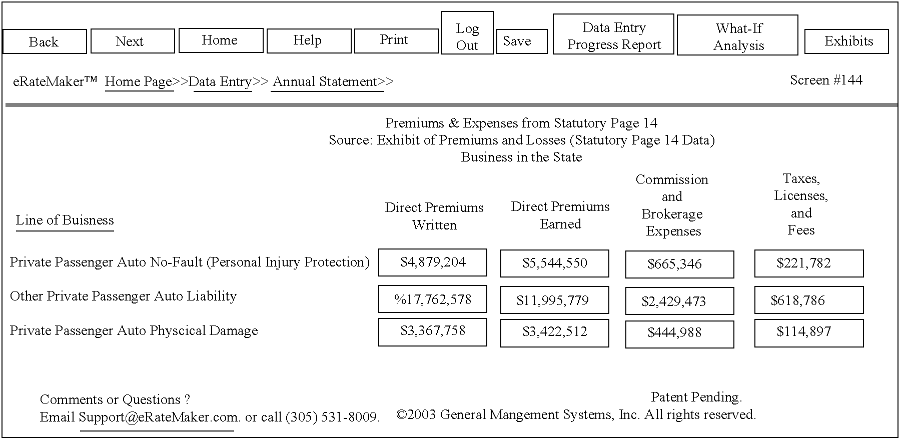

TABLE 27

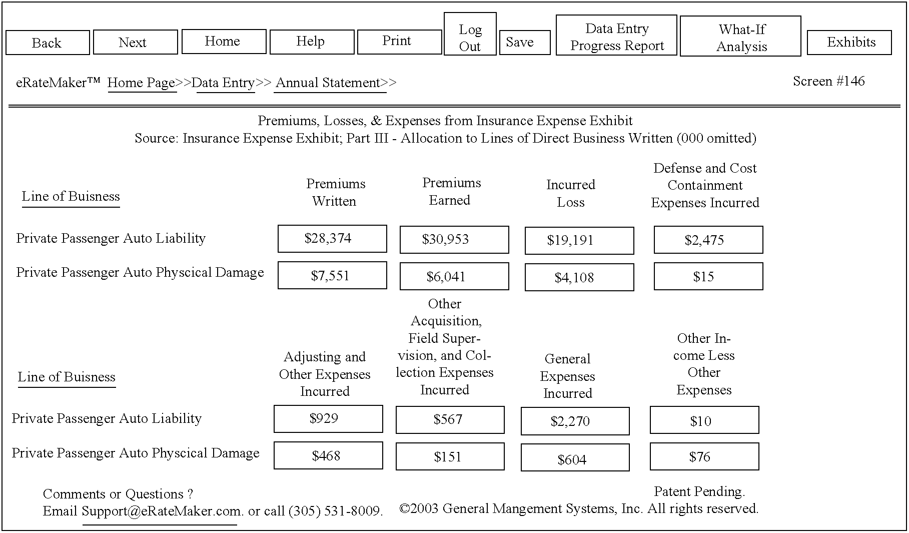

The “Taxes, Licenses, & Fees” section accepts such expenses for the latest fiscal year 161, as illustrated in the exemplary web page shown as Table 28.

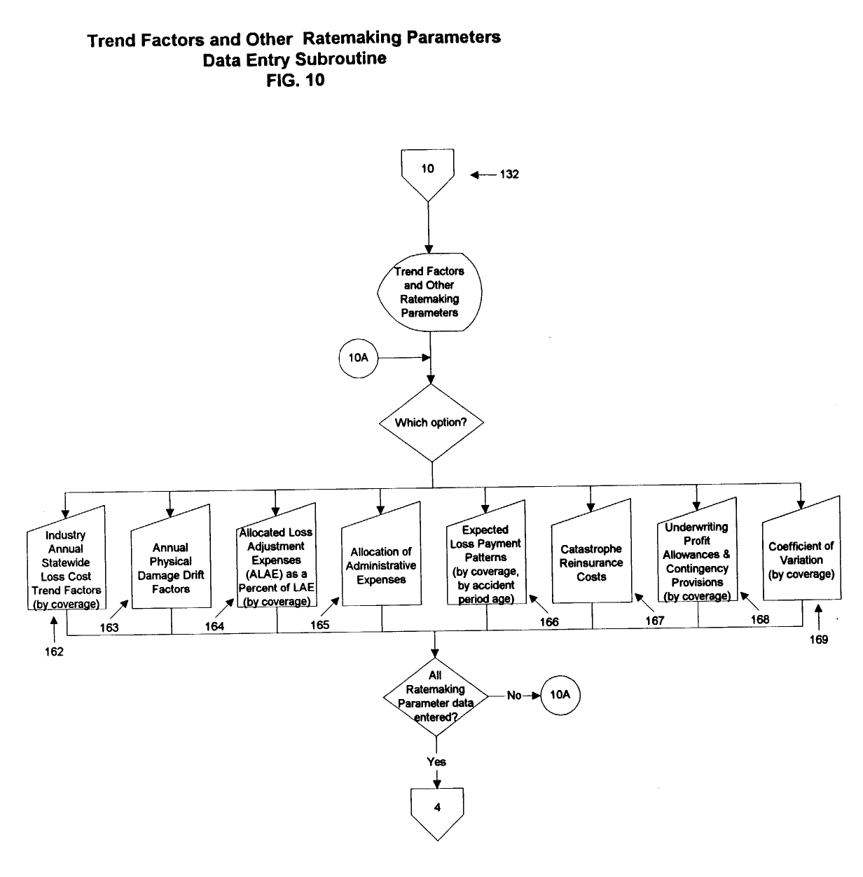

The next and fifth data entry subsystem pertains to “Trend Factors and Other Ratemaking Parameters”. It has eight steps, as illustrated in the exemplary web page shown as Table 29, and as flow diagrammed in FIG. 10. Enter:

1. Industry Annual Statewide Loss Cost Trend Factors 162,

2. Annual Physical Damage Drift Factors 163,

3. Allocated Loss Adjustment Expense (ALAE) as a Percent of LAE 164,

4. Allocation of Administrative Expenses 165,

5. Expected Loss Payment Patterns 166,

6. Catastrophe Reinsurance Costs 167,

7. Underwriting Profit Allowances & Contingency Provisions 168, and

8. Coefficient of Variation 169.

TABLE 28

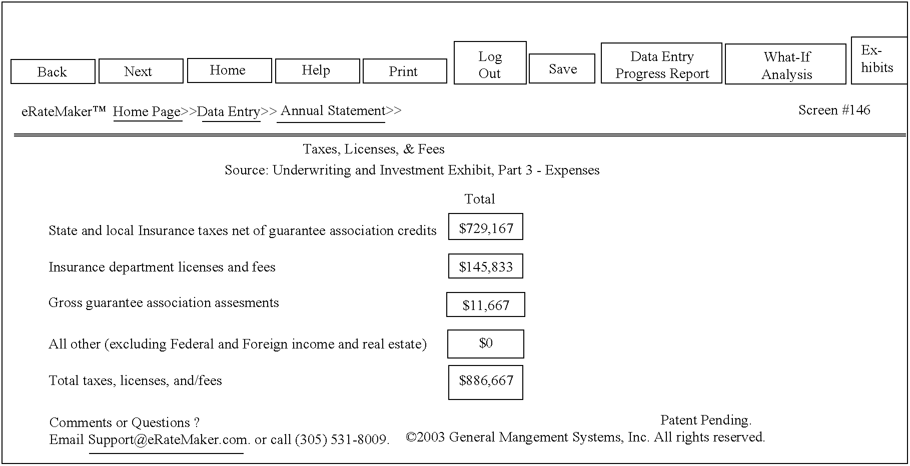

TABLE 29

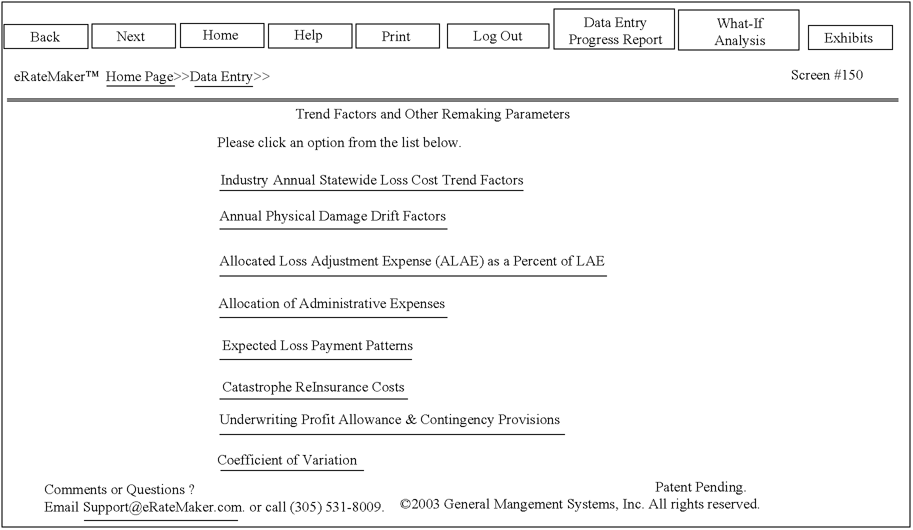

The “Industry Annual Statewide Loss Cost Trend Factors” section accepts the minimum and maximum annual trend factors that the ratemaking computer program considers in projecting average claim costs 162, as illustrated in the exemplary web page shown as Table 30. Default values are offered.

TABLE 30

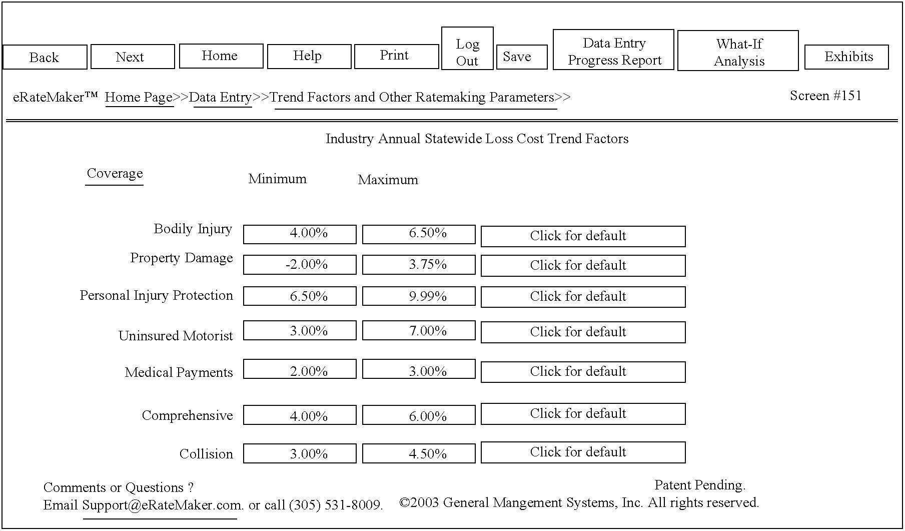

The exemplary “Annual Physical Damage Drift Factors” section accepts estimates of the annual drift factors for Vehicle Symbols and Vehicle Model Years for the Comprehensive and Collision insurance coverages 163, as illustrated in the exemplary web page shown as Table 31. (Vehicle Symbols and their assigned premium relativity factors measure, primarily, the original price of the car; Vehicle Model Years and their assigned premium relativity factors take into account, primarily, the depreciation of the car.) Default values are offered.

TABLE 31

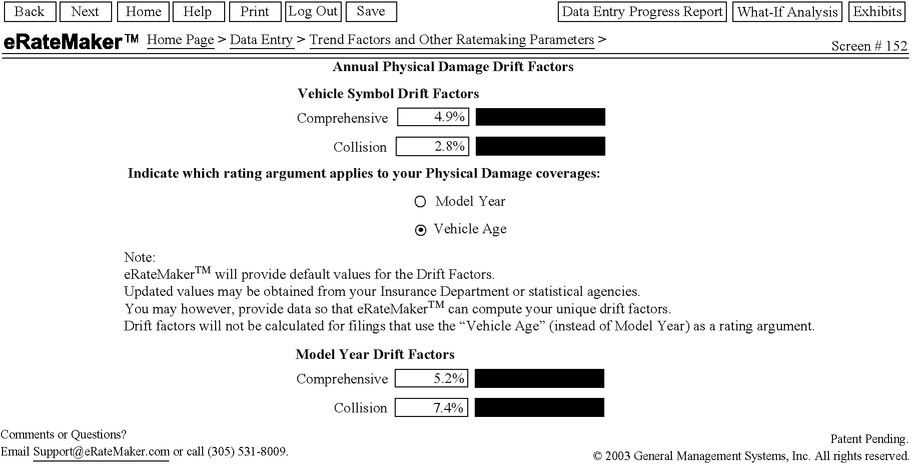

The “Allocated Loss Adjustment Expense (ALAE) as a percent of LAE” section accepts the user's estimate of allocated loss adjustment expenses as a percent of total loss adjustment expenses 164, as illustrated in Table 32. Default values are offered.

TABLE 32

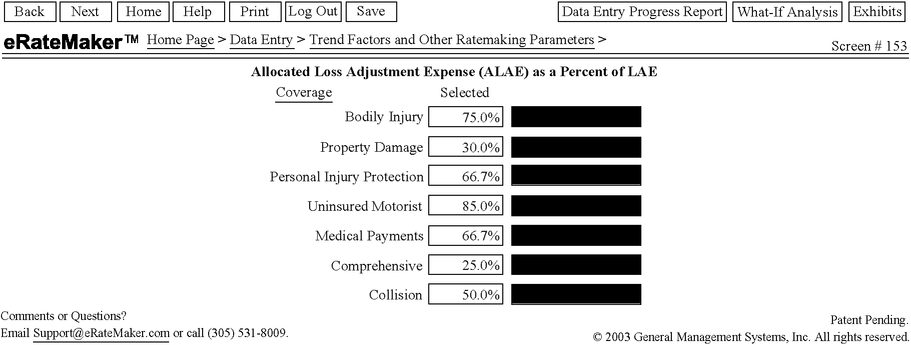

The “Allocation of Administrative Expenses” section accepts the percentage of certain administrative expenses that do not vary with the premium charged 165. Such expenses are fixed and charged as a fee. They include: Other Acquisition Expenses, Miscellaneous Licenses & Fees, General Expenses, and Other Special Expenses. Default values are offered. Table 33 is an exemplary web page that the user employs to enter the percentages.

TABLE 33

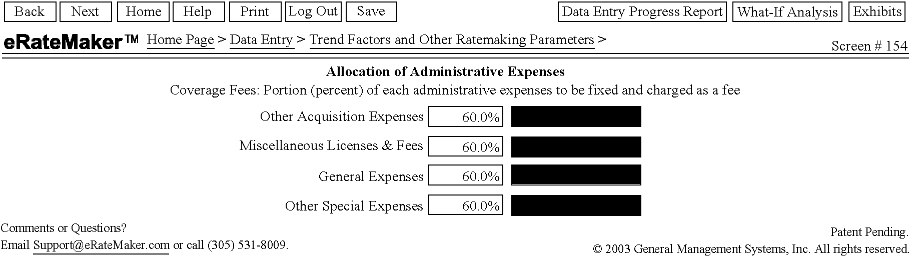

The “Expected Loss Payment Patterns” section accepts the expected cumulative percent of losses paid at of the close of each accident year 166, as illustrated in the exemplary web page shown as Table 34. Default values are offered.

TABLE 34

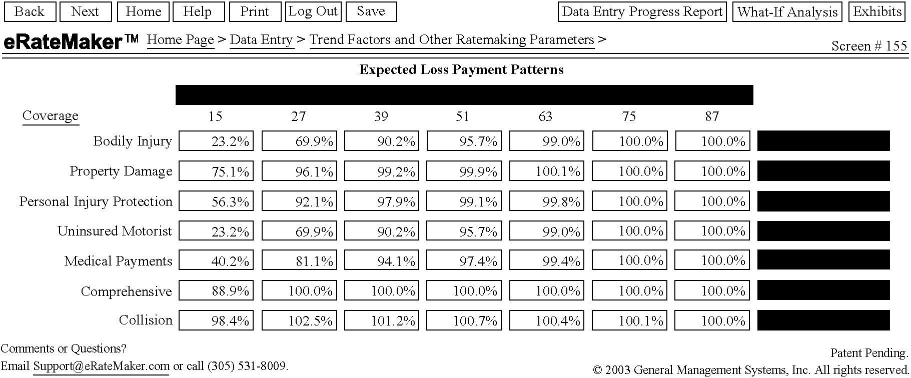

The “Catastrophe Reinsurance Costs” section accepts when applicable, the cost of catastrophe reinsurance as a percent of the exemplary Comprehensive coverage earned premium 167, as illustrated in the exemplary web page shown as Table 35.

TABLE 35

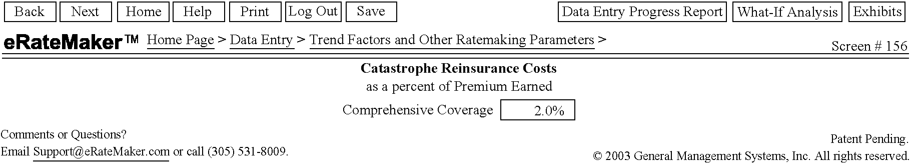

The “Underwriting Profit Allowances & Contingency Provisions” section accepts the user's target profit allowance (as a percent of premium) and a contingency provision (as a percent of premium) 168, as illustrated in the exemplary web page shown as Table 36. Default values are offered.

TABLE 36

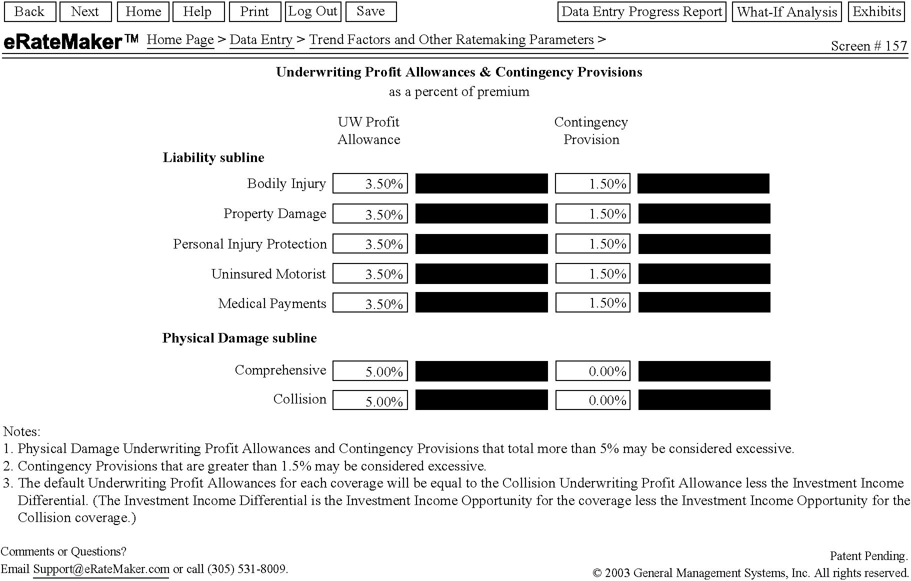

The “Coefficients of Variation” section accepts, for each coverage, a coefficient, which represents the ratio of the standard deviation of the “cost per claim” to the average “cost per claim” 169, as illustrated in the exemplary web page shown as Table 37. Default values are offered.

TABLE 37

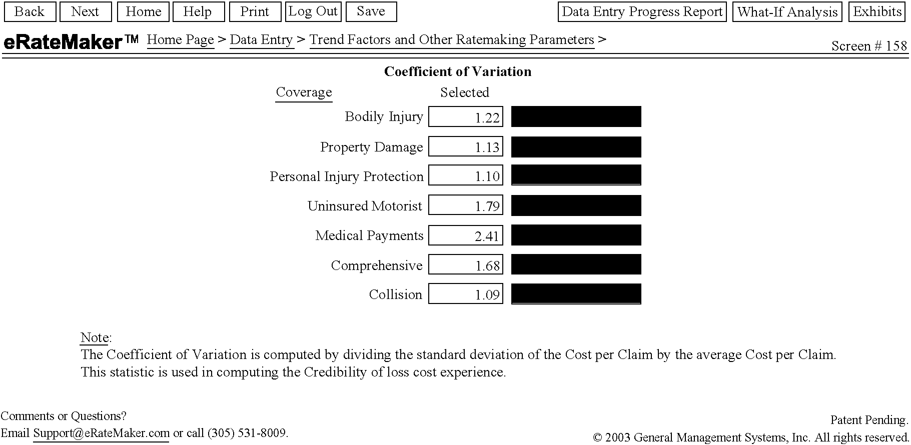

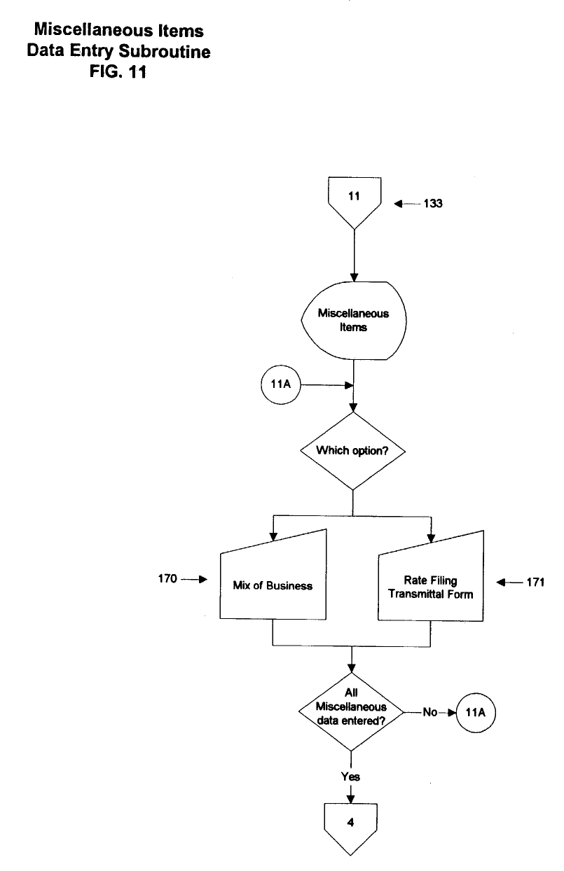

The last of the six data entry sub-systems pertains to “Miscellaneous Items”. It has two steps as illustrated in Table 38 and as flow diagrammed in FIG. 11. Enter:

1. Mix of Business 170, and

2. Rate Filing Transmittal Form 171.

TABLE 38

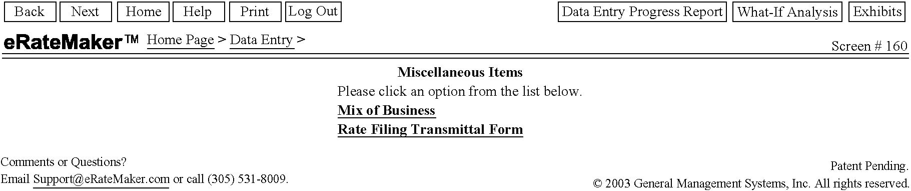

The “Mix of Business” section accepts the current and expected percent distributions of premium earned, by policy term 170, as illustrated in the exemplary web page shown as Table 39.

TABLE 39

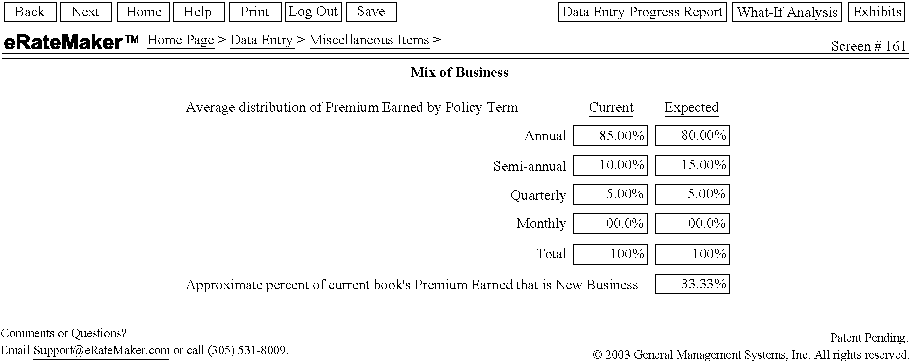

The “Rate Filing Transmittal Form“section accepts identification data pertaining to the insurance company, contact personnel, and the filing 171, as illustrated in the exemplary web page shown as Table 40.

TABLE 40

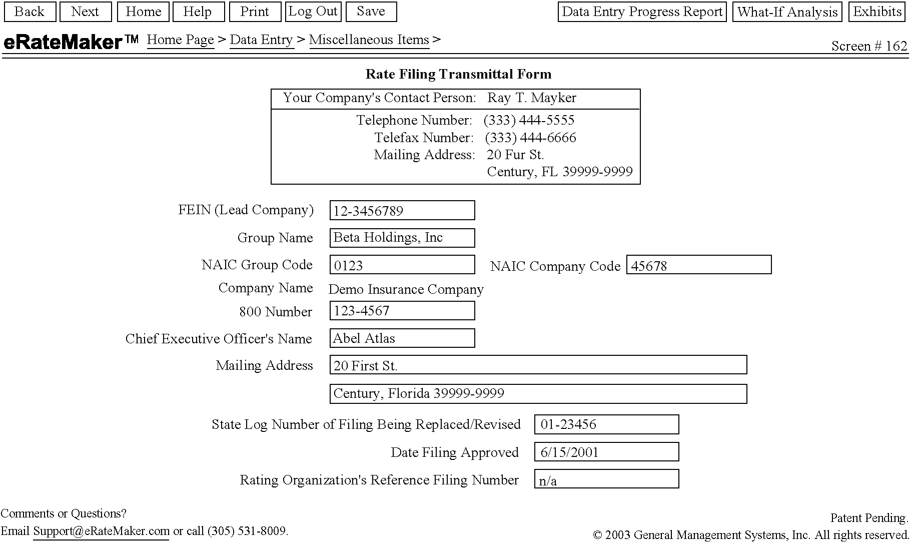

Once the data have been entered, into the six data entry sub-systems, the computer ratemaking program automatically generates a complete set of insurance rates and actuarial exhibits. A listing of the exemplary actuarial exhibits is provided in Table 41.

TABLE 41
EXHIBITS FOR ALL COVERAGES COMBINED
Summary of Proposed Rate Level Changes
Premium Breakdown, by Coverage and Combined: Selected Provisions
Proposed Rate Changes in Full Coverage Policies: by Driver Class, by Territory
Proposed Driver Class Relativity Factors
Proposed Territory Base Rates (excluding Fees)
Physical Damage Factors, Point Surcharge Factors, Increased Limit and Deductible Factors
Federal and State Income Tax Rates
Expected Yield on Future Investment Portfolio
Projected Loss & ALAE Ratios and Combined Ratios (at Current Cost Level)
EXHIBITS FOR EACH COVERAGE
Determination of Indicated Average Statewide Rate Level Change
Summary of Indicated and Proposed Average Statewide Rate Level Changes
Projected Loss & Allocated Loss Adjustment Expenses
Reported Losses & Allocated Loss Adjustment Expenses (Net of Salvage & Subrogation Rece [symbol]
Paid Losses & Allocated Loss Adjustment Expenses (Net of Salvage & Subrogation Received)
Statewide Current Rate Level Factors
Development of Trending Period and Projection Factors
Selection of Loss Cost Trend Factors
Development of Severity Trend Factor
Development of Frequency Trend Factor
Number of Reported Claims
Development of Target Loss Ratio
Underwriting Expenses
Development of the Discounted Value of the Expected Loss Payment Pattern
Determination of Expected Number of Car Years Earned for Selected Level of Credibility of L [symbol]
Cost
Calculation of Fixed Administrative Expense Fee
Fees and Driver Class Relativity Factors Earned by Accident Period
Development of Earned Driver Class Relativity Factors for all Accident Periods Combined
Development of Earned Premium at Current Rate Level by Driver Class (for each Accident P [symbol]
Development of losses & LAE by Driver Class (for each Accident Period)
Development of Indicated Driver Class Relativities
Calculation of Proposed Change in Driver Class Relativity Factors
Fees and Territory Base Rates Earned by Accident Period
Development of Earned Territory Base Rates for all Accident Periods Combined
Development of Earned Premium at Current Rate Level by Territory (for each Accident Perio [symbol]
Development of Losses & LAE by Territory (for each Accident Period)
Development of Indicated Territory Relativities
Calculation of Proposed Changes in Territory Base Rates

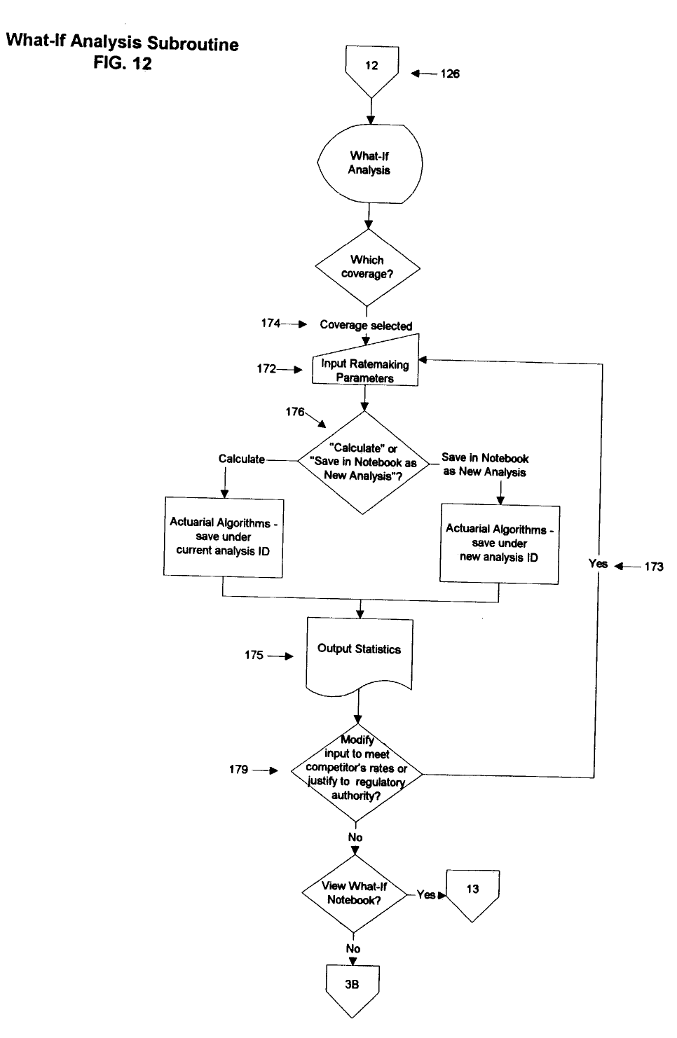

The user needs not be concerned with any of the math, inter-relationships, logic, or mechanics of the actuarial algorithms. He needs only move on to the sensitivity, “What-If”, analysis, the second of the system's three ratemaking stages, which is illustrated in FIG. 12. The “What-If” analysis allows the user to test the effect of the following input ratemaking parameters 172:

1. Expense Ratios,

2. the Contingency Provision,

3. the Underwriting Profit Allowance,

4. the Unallocated Loss Adjustment Expense,

5. the Loss Cost Trend factor,

6. the Maximum Increase and the Maximum Decrease for each major risk classification,

7. Loss Development Parameters,

8. Credibility Parameters,

9. the Application of Credibility Complements, and

10. the Statewide Base Rate.

The initial assumptions are default values that the computer ratemaking program generates; while succeeding assumptions 173 are values that the user provides. “What-If” analyses are conducted separately on each insurance coverage 174 as indicated in the exemplary web page shown as Table 42.

TABLE 42

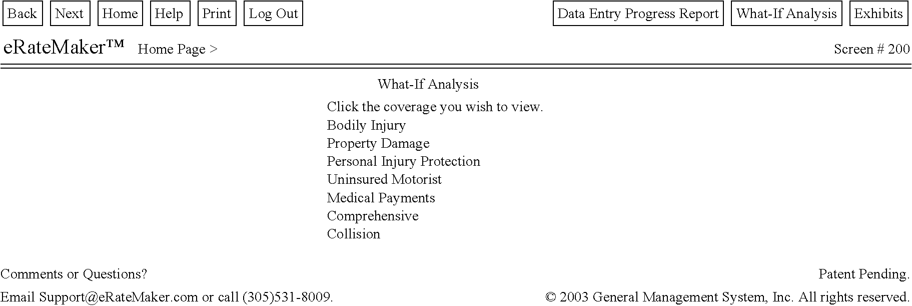

The output statistics 175 provide summary data for each insurance coverage, and for all coverages combined. The output statistics 175, as shown in Table 43, are:

1. Indicated and Selected Rate Level Changes for the insurance coverage analyzed and for all coverages combined, and

2. the Maximum Increase and the Maximum Decrease for an insured for the insurance coverage analyzed and for all coverages combined.

The user changes the input ratemaking parameters 172 by way of text boxes, options buttons, and list boxes that are linked to the input parameters 172. Buttons to view a log (“What-If” Notebook) of all the saved analyses, to generate (“Calculate”) new rates and exhibits, and to save new analyses 176 are provided.

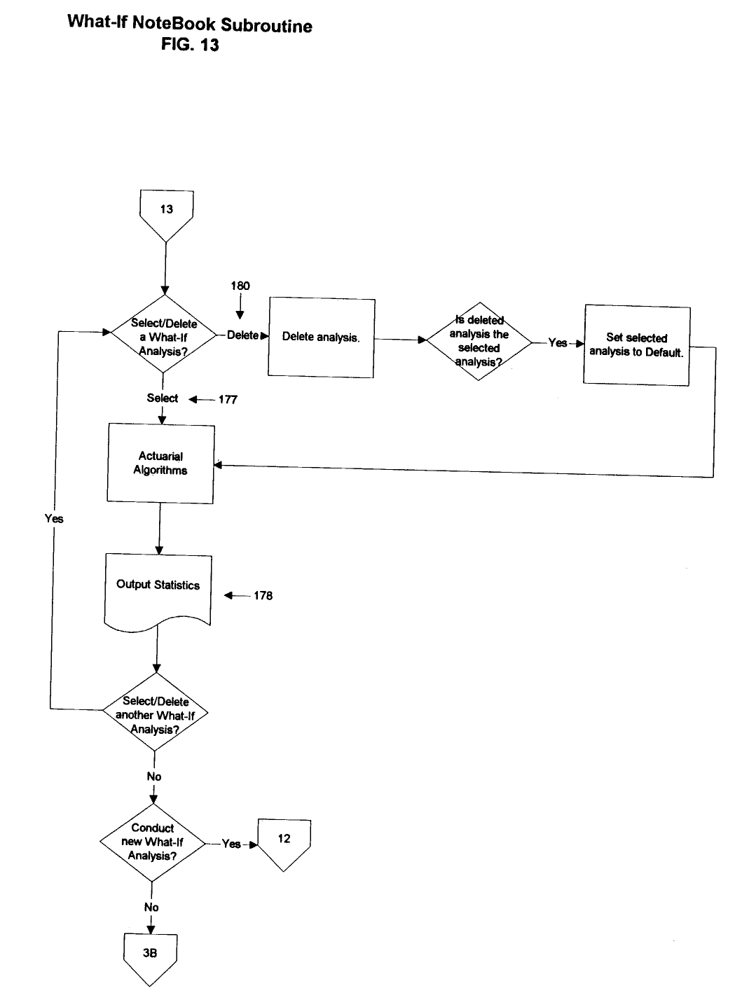

An exemplary web page of the “What-If Notebook” is shown as Table 44 and illustrated by way of a flow diagram in FIG. 13. The user can save 176 and compare any and all of the “What-If” analyses before selecting a final set of ratemaking parameters. All the output statistics and input ratemaking parameters are stored and displayed in the “Notebook”. Every time the user selects 177, in the Notebook, a saved set of ratemaking parameters, a new set of output statistics and actuarial exhibits are generated 178. The “What-If Notebook” displays two loss ratios for each “What-If” analysis: (1) the “Expected Loss & ALAE ratio” if the ratemaking computer program's parameters are assumed and (2) the “Target Loss & ALAE ratio” if the user's input ratemaking parameters are assumed. The parameters determined by the ratemaking computer program are assumed to be the most actuarially sound. A user may modify the ratemaking parameters in an attempt to meet competition's rates or justify, to a regulatory authority 179, a rate change that is either higher or lower than what is actuarially sound. The first loss ratio is an attempt to measure the consequences of such modifications. (“Loss & ALAE ratio”, as used in this discussion, is the ratio of projected claims and loss adjustment expenses to earned premiums).

TABLE 43

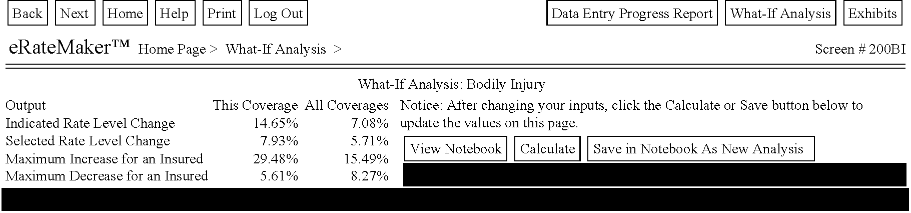

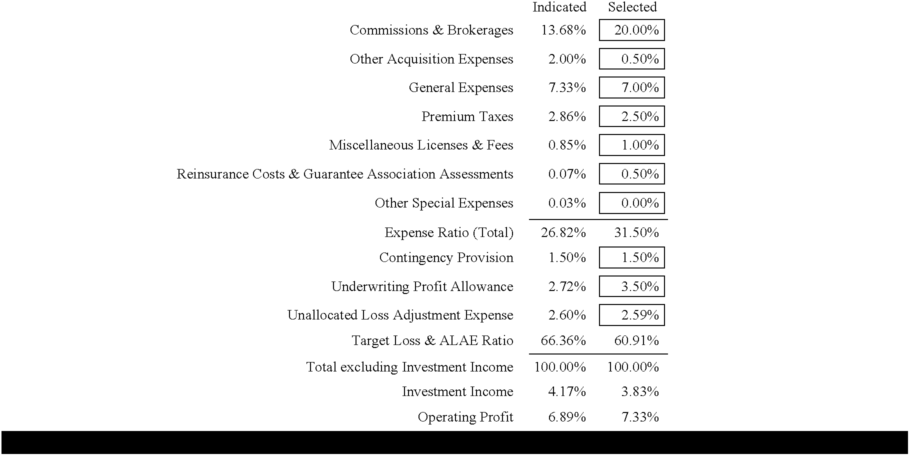

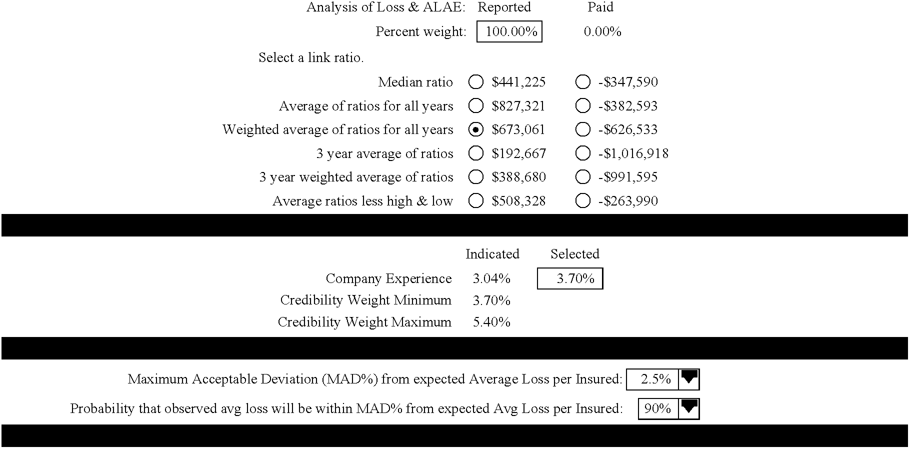

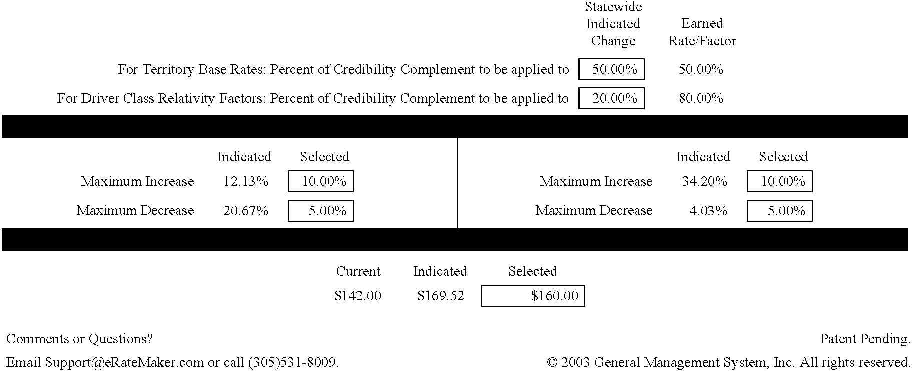

TABLE 44

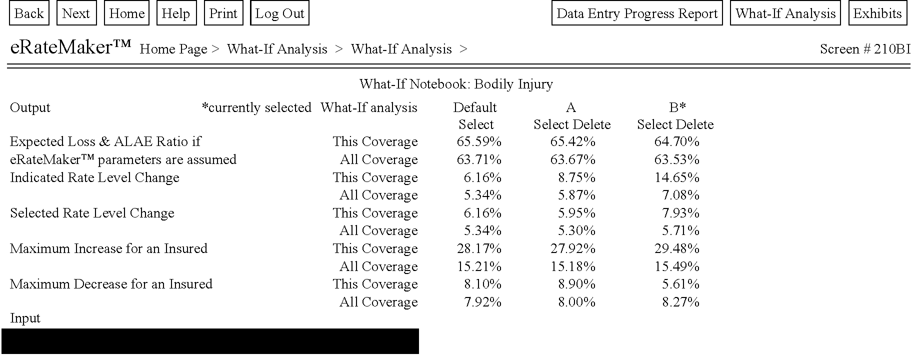

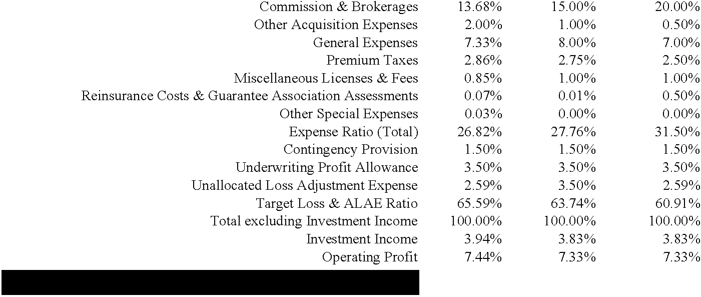

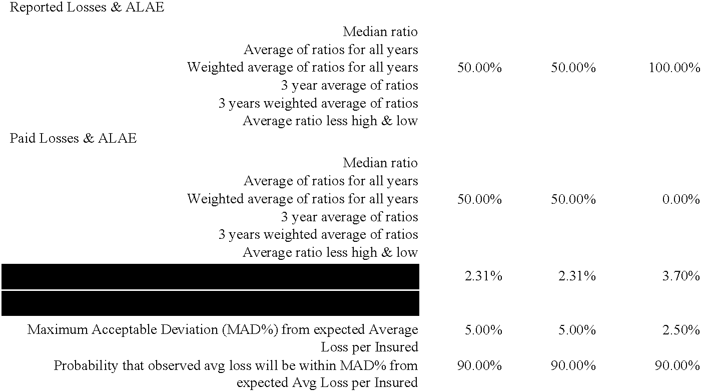

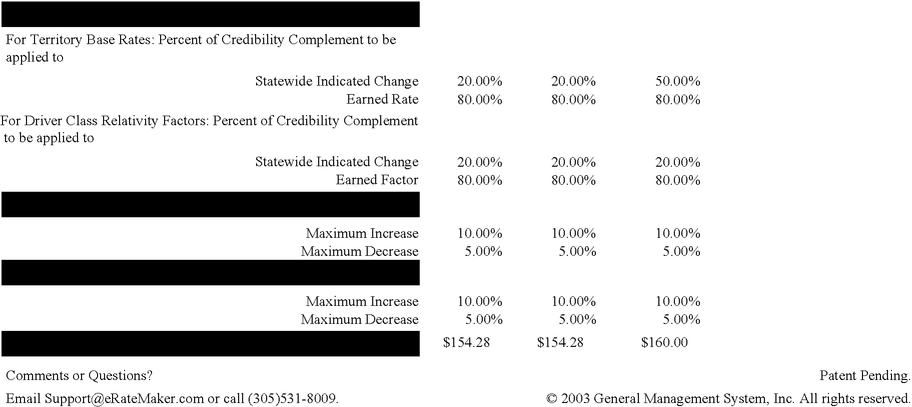

The user also has the ability to delete 180 saved analyses from the What If Notebook.

Web pages of any exhibit can be printed by the user's browser (e.g. Microsoft Internet Explorer and Netscape Navigator) as the web pages are viewed on the user's screen. Such printing is accomplished by way of a “Print” button on the browser's tool bar or on the ratemaking computer program's navigation bar.

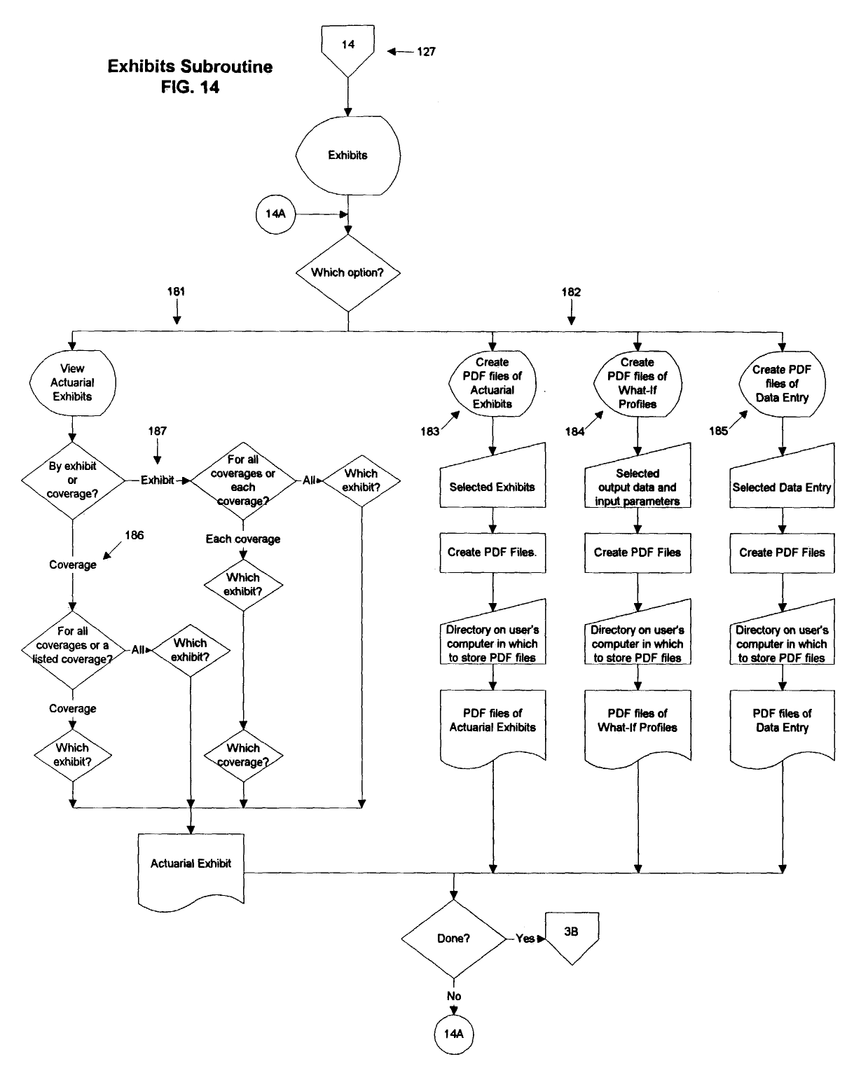

“Exhibits” is the last of the system's three ratemaking stages. In this stage, as illustrated in the flow diagram in FIG. 14, the user is given the ability to view specific exhibits 181; and to create and store the exhibits as portable document format files 182. Links to each option are provided in the web page shown as Table 45. The exhibits are classified as:

1. Actuarial Exhibits 183,

2. What-If Profiles 184, and

3. Data Entry Web Pages 185

TABLE 45

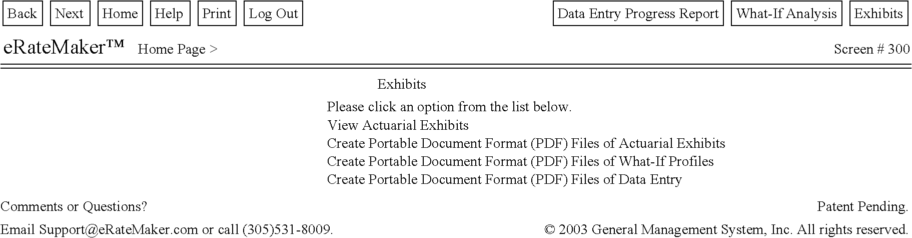

By way of drop down list boxes, the user can search for and view any actuarial exhibit, as illustrated in the exemplary web page shown as Table 46.

TABLE 46

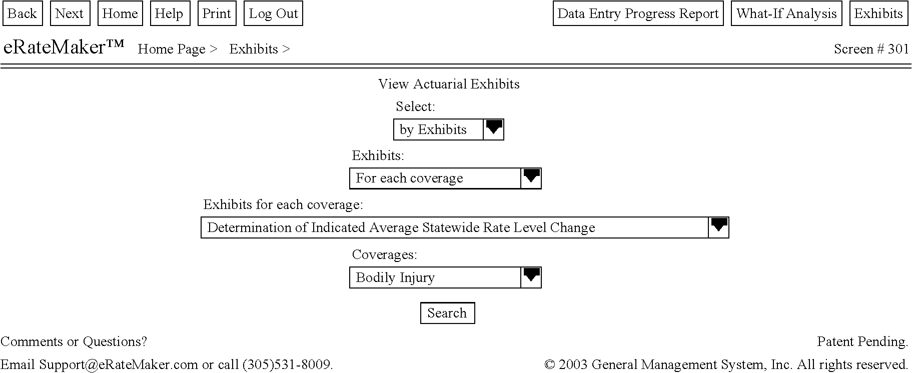

A search routine allows the user to view the exhibits by insurance coverage 186 or alternatively, the coverages by type of actuarial exhibit 187. An exemplary actuarial exhibit is presented in the exemplary web page shown as Table 47.

TABLE 47

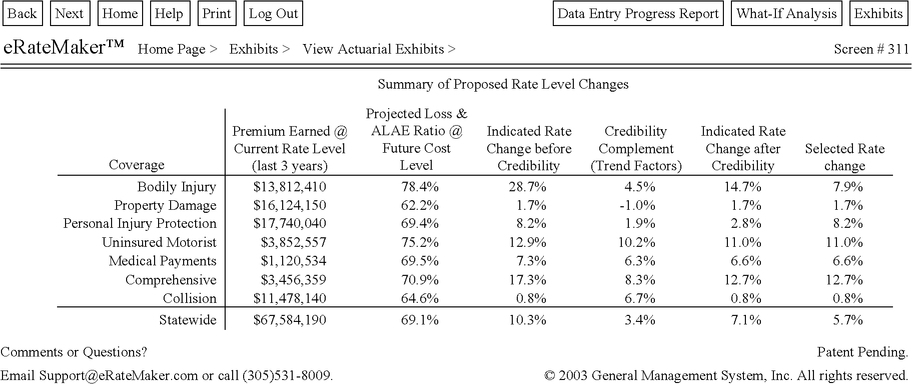

Bulk printing and storage of selected exhibits is accomplished by converting the exhibits to portable document format (PDF) files 182. The PDF files can be stored on the user's computer, and then printed and/or electronically transmitted to his regulatory authority. The user selects the exhibits that he wants included in each PDF file, accepts or enters a default name for each file to be created and points to an output folder, on his computer, where the files are to be stored. Web pages, that the user activates to create PDF files, are shown as Table 48 through Table 51. Table 48 is the-web page that the user employs to select and create PDF files of actuarial exhibits, for all the insurance coverages combined, or for each coverage separately. Should the user not want all the available actuarial exhibits, he can click on a “Details” command button. As shown in Table 49, an exemplary web page, the button provides a list of the different categories of actuarial exhibits. Should the user not want all the available actuarial exhibits within a category, he can, once again, click on a “Details” command button which will provide a list of the actuarial exhibits within the category.

TABLE 48

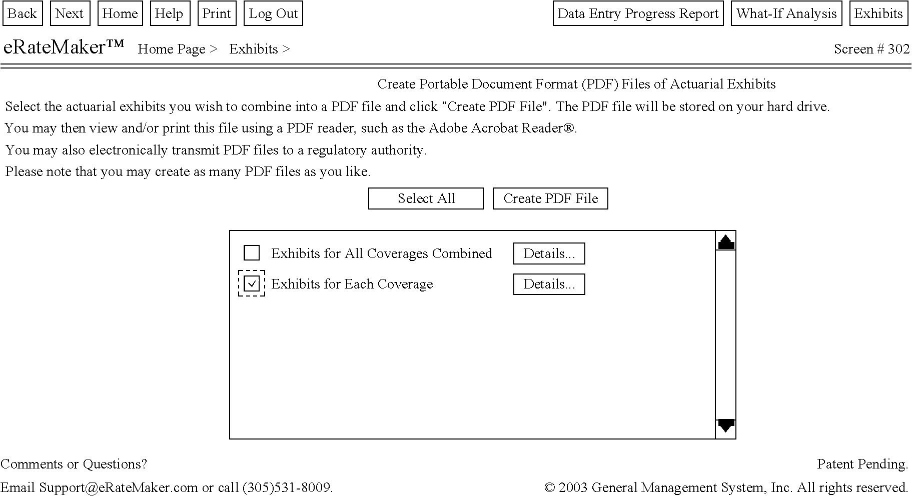

TABLE 49

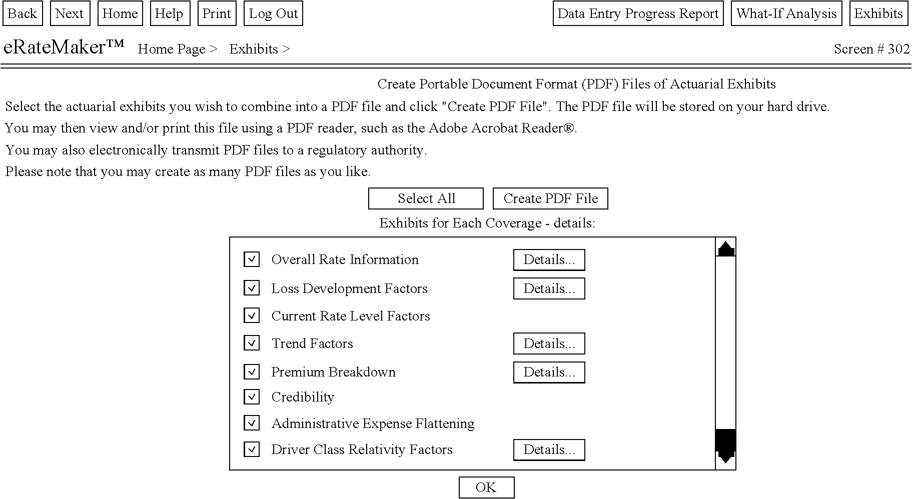

Similar features are provided for the “What-If Profiles” exhibits (Table 50 ) and the data entry exhibits (Table 51).

TABLE 50

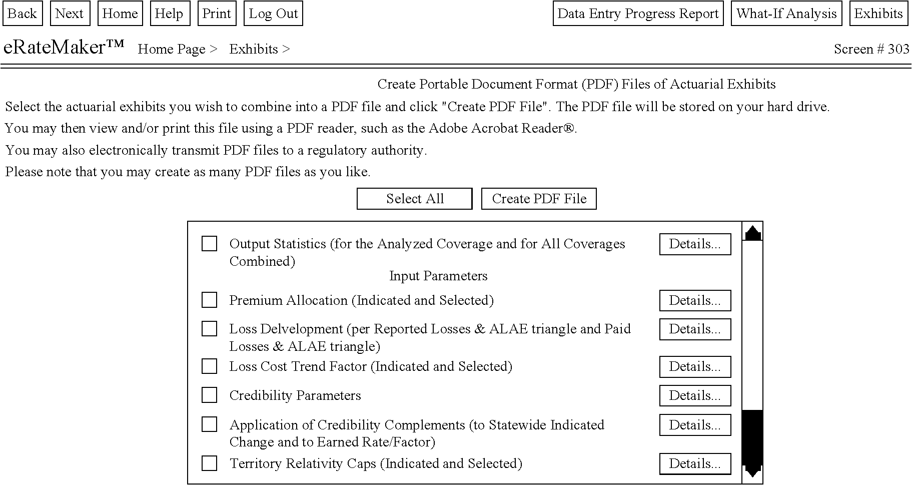

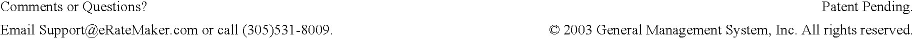

TABLE 51

| | |
|---|---|
| 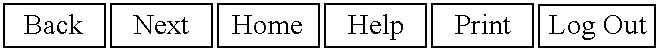 | 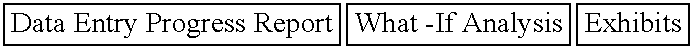 |

| | |
|---|---|
| eRateMaker™ Home Page > Exhibits > | Screen # 304 |

Create Portable Document Format (PDF) Files of Data Entry

Select the data entry sheets you wish to combine into a PDF file and click “Create PDF File”,
The PDF file will be stored on your hard drive,
You may then view andlor print this file using a PDF reader, such as the Adobe Acrobat Reader ®.
You may also electronically transmit PDF files to a regulatory authority.
Please note that you may create as many PDF files as you like.

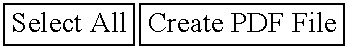

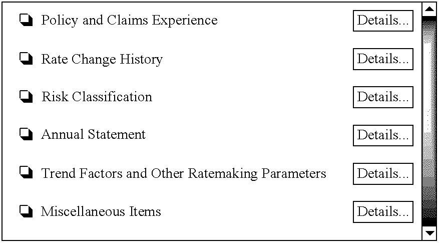

Finally the user can give his regulatory authority, a password that will allow the regulatory authority to access the “What-If” analysis module and test the ratemaking parameters on the user's underwriting experience.

The “Help” features of the ratemaking computer program comprise:

1. Context sensitive help keys,

2. a glossary of insurance terms, and

3. progress bars that display, for the user, how long it will take to complete a request.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A system for facilitating the determination of property and casualty insurance rates comprising:
a computer network interface;
a computer server coupled to the computer network interface
for receiving ratemaking data received from at least one user across a computer network,
for processing the ratemaking data, and
for sending rates and actuarial exhibits to the at least one user; and
at least one communication device coupled to the computer network interface
for sending the ratemaking data across the computer network to the computer server,
for receiving from the computer server, the rates and the actuarial exhibits.

2. The system for facilitating the determination of property and casualty insurance rates of claim 1, wherein the computer network is a wide area network.

3. The system for facilitating the determination of property and casualty insurance rates of claim 1, wherein the computer network is the Internet; the computer server is coupled to the Internet and the computer server operates with a web server to provide the at least one user access to the system for facilitating the determination of property and casualty insurance rates.

4. The system for facilitating the determination of property and casualty insurance rates of claim 1, further comprising a local area network coupled to the communication device and to the Internet wherein the computer network is the Internet; and the computer server is coupled to the Internet to provide the at least one user access to the system for facilitating the determination of property and casualty insurance rates.

5. A method for a system for facilitating the determination of property and casualty insurance rates comprising the steps of:
receiving ratemaking data from at least one user; and
classifying the ratemaking data.

6. The method of claim 5, wherein the at least one user sends ratemaking data to a computer server via the Internet.

7. The ratemaking method as claimed in claim 5, wherein the ratemaking data comprise any flat-file database of insurance policy and claims data.

8. The ratemaking method as claimed in claim 5, comprising the further steps of
detecting and displaying data entry errors found in the policy and claims databanks, and
accepting changes to the data entry errors.

9. The ratemaking method as claimed in claim 5, comprising the further steps of
formatting the ratemaking data, and
storing the ratemaking data.

10. The ratemaking method as claimed in claim 5, comprising the further steps of providing default values pertaining to insurance industry averages or insurance industry trends.

11. The ratemaking method as claimed in claim 5, comprising the further step of providing a data entry progress report.

12. The ratemaking method as claimed in claim 5, comprising the further step of providing a sensitivity analysis model comprising input ratemaking parameters and output rate level information.

13. The ratemaking method as claimed in claim 12, comprising the further step of providing a log for displaying the input ratemaking parameters and the output rate level information.

14. The ratemaking method as claimed in claim 13, comprising the further step of selecting concluding input ratemaking parameters by the at least one user.

15. The ratemaking method as claimed in claim 12, comprising the further step of providing an actuarial measure of the effect caused by a modification of default input ratemaking parameters.

16. The ratemaking method as claimed in claim 5, comprising the further step of providing rates and actuarial exhibits.

17. The ratemaking method as claimed in claim 5, comprising the further step of storing the ratemaking data for future ratemaking projects.

18. The ratemaking method as claimed in claim 17, comprising the further step of appending new policy and claims data to the ratemaking data.
